(19) United States
(12) Patent Application Publication
(10) Pub. No.: US 2013/0066675 A1
(43) Pub. Date: Mar. 14, 2013

(54) DUAL-PURPOSE AUTOMATED SYSTEM THAT PROVIDES A CONSUMER INTERFACE AND A CLIENT INTERFACE

(71) Applicant: Robert Hyer Bercaw, Kirkland, WA (US)

(72) Inventor: Robert Hyer Bercaw, Kirkland, WA (US)

(21) Appl. No.: 13/607,158

(22) Filed: Sep. 7, 2012

Related U.S. Application Data
(60) Provisional application No. 61/532,020, filed on Sep. 7, 2011.

(51) Int. Cl. G06Q 30/02

(52) U.S. Cl. 705/7.29

(57) ABSTRACT

The current application discloses a dual-purpose automated system and related methods for collecting consumer data by providing a product-and-services consumer recommendation service and using the collected data to provide market research and analyses to clients. The consumer recommendation service assists consumers in evaluating and choosing particular products and services from among certain available and/or hypothetical products and services and, during operation, electronically stores information obtained from consumer interactions with the consumer recommendation service that is used as a basis for providing market-research data and analyses to retailers, manufactures, and other clients.

### CROSS-REFERENCE TO RELATED APPLICATION

This application claims the benefit of Provisional Application No. 61/532,020, filed Sep. 7, 2011.

### TECHNICAL FIELD

The current application is related to dual-purpose automated systems and, in particular, to a class of dual-purpose automated systems that each provides a client interface through which clients receive market-research data and analyses and a consumer interface through which consumers receive information about products and service.

### BACKGROUND

The market-research industry has expended extensive efforts to provide pricing of products and services using techniques including conjoint analyses and discrete-choice analyses. The models developed for these techniques are quite sophisticated, but they generally rely on collecting honest and well-considered answers from respondents whose interests are not necessarily aligned with providing such answers.

Currently, the market-research industry generally uses market-research studies in which respondents join panels and participate in market studies in order to receive points. When the respondents accumulate enough points, they redeem the points for cash, products, or services. The compensation received by respondents averages about $1.75/hour. When a respondent successfully completes an entire study, the respondent can earn an amount equivalent to between $5 and $20. Completing the entire survey is not necessarily an easy task. The market researcher often asks whether or not the respondent is planning on buying a product in the next few months and, when the respondent answers negatively, the respondent is generally removed from the study. The respondents quickly learn to answer these types of evaluation questions falsely in order to remain on the panel. The market researchers desire respondents who are knowledgeable about the products that are being studied and who are honest about what they are willing to pay for those products, so they often include trap questions to detect respondents likely to provide false or unreliable answers. Respondents quickly learn to detect and appropriately respond to trap questions, as a result of which an ongoing battle ensues between the researchers and the respondents in which each strives to outwit the other.

The above-described battle between researchers and respondents has generally resulted in collection of poor data by many market researchers. As one example, 15% of the respondents on one panel stated an intent to buy a particular product during the following month, when less than 1% of the general population could reasonably be expected to buy the product in a given month. Without trap questions, the likelihood of false answers would exceed reasonable thresholds for collecting meaningful data. However, trap questions have limited effectiveness, particularly when presented to experienced respondents. As more and more trap questions are included and more honest respondents are eliminated, the acceptance rate for respondents may fall below cost-effective levels. In the end, despite use of trap questions and other research devices, market researchers have no way of really knowing the percentage of dishonest respondents selected for surveys and panels. They also generally have no way of knowing whether respondents were previously actively researching products about which they are surveyed, and are therefore knowledgeable, and generally have no way of determining whether or not the respondents subsequently shop for, and purchase, the products about which they are surveyed.

Since the 1970s the market-research industry has developed a number of sophisticated techniques for inducing market-research respondents to tell them how much they would be willing to pay for different features, products, and services. Rather than ask them directly, market researchers generally craft ways of offering the respondent a choice between various alternatives and features. The market researchers then use various techniques to determine how much a respondent would pay for each feature and to what degree a respondent prefers one hypothetical product to another. These techniques are crafted by market research professionals on behalf of manufacturers who desire to make pricing and product-feature decisions. The manufacturers often want to know how consumers feel about dozens of different products and features and the correspondingly complex and detailed studies can take anywhere from 15 minutes to 45 minutes for a respondent to complete. These extensive studies tax the respondent's ability to complete the study, stay focused, and be knowledgeable about the various features. The studies generally do not correspond to the way that consumers actually choose products. Market researchers believe that, when evaluating products in crowded product spaces and products with many features, most consumers use a two-step process of first paring down the product or feature space by using exclusionary rules, carrying out a rule-based filtering step, and then making tradeoff decisions among the remaining products or features. While market researchers have tried to emulate this decision-making process in their studies, their efforts are often frustrated by the volume of market-research information sought by manufacturers.

The developers of these techniques have argued that they accurately predict how the respondent would act in a real-world situation. To prove this, certain developers have developed tests for situations where they have some ability to measure real-world decisions. For example, in one approach, college students are asked about the job offers that they would be willing to accept and are then subsequently asked, after graduation, what job offers they ended up accepting. These tests have been limited in scope. So far, the tests have not been used to refine the testing techniques or to increase the accuracy and predictability of testing.

Consumers often have a difficult time selecting the best product or service from a set of available products and services. They are particularly challenged by product spaces where there are a large number of available products and associated features, including product spaces such as eReaders, lawn mowers, and kitchen appliances. Currently, consumers can access various aids in selecting products. These include human-written buyers' guides, written by a reviewer uses the various products, writes about the products, and very often makes a recommendation about which products the reviewer believes to be best. The appeal of buyers' guides is that they spare a consumer the time and effort needed to conduct detailed product surveys. In many ways, large retailers, such as Costco, provide much the same benefit by reviewing products and selling those about which they receive most favorable reviews. The downside of such services is that they tend to reflect preferences and interests of one or a few people, and not those of particular consumers. Reading through individual product reviews can also be a time-consuming and frustrating process. In addition, tables of products and features have been compiled to allow consumers to compare different products to one another. These tables are often comprehensive, but accessing the information contained within them can be a time-consuming and frustrating process. A third approach involves providing consumers with a set of filters that allow the consumers to reduce the set of available products for consideration to a manageable size. Very often, application of these filters to a product space leaves either too many products or too few products to choose from, and may inadvertently eliminate products that, when fully considered, would be attractive to certain consumers despite failing to pass a particular filter.

### SUMMARY

The current application discloses a dual-purpose automated system and related methods for collecting consumer data by providing a product-and-services consumer recommendation service and using the collected data to provide market research and analyses to clients. The consumer recommendation service assists consumers in evaluating and choosing particular products and services from among certain available and/or hypothetical products and services and, during operation, electronically stores information obtained from consumer interactions with the consumer recommendation service that is used as a basis for providing market-research data and analyses to retailers, manufactures, and other clients.

### BRIEF DESCRIPTION OF THE DRAWINGS

FIGS. 1A-B illustrate example system-hardware environments.

FIGS. 2-7 illustrate an example of a consumer interface through which consumers obtain product information from a dual-purpose automated system (“DP system”).

FIGS. 8-13 illustrate various example results and analyses made available to clients through the client interface of an example DP system.

FIGS. 14-16 provide control-flow diagrams that describe high-level aspects of an example DP system.

FIG. 17 illustrates many different types of information obtained from consumers during consumer-interface sessions that a DP system records for various purposes.

FIG. 18 illustrates various ways that the many different types of information obtained from consumers during consumer-interface sessions, discussed with respect to FIG. 17, can be used by a DP system.

FIG. 19 illustrates the type of data that may be stored within a DP system.

FIGS. 20-23 illustrate underlying operations carried out by a DP system during the initial portion of a consumer-interface session.

FIG. 24 illustrates a full combinatorial experimental design for a four-factor experiment.

FIG. 25 illustrates an orthogonal array that can be used as the experiment design for a four 3-level factor experiment, a full combinatorial experimental design for which is shown in FIG. 24.

FIG. 26 illustrates analysis of experimental results produced by an orthogonal-array experiment design.

FIG. 27 illustrates a number of orthogonal arrays.

FIG. 28 illustrates an example experimental design, based on the above-described orthogonal-array technique, and generation of a set of product descriptions based on the experimental design.

FIG. 29 shows an example DP-system computation involved in ranking available products for selection and subsequent display to a consumer on the final results page provided to the consumer.

### DETAILED DESCRIPTION

The current application is directed to a dual-purpose, automated system (“DP system”) that provides a product-and-services consumer-recommendation service through a consumer interface and that provides market research and analyses through a client interface. The product-and-services consumer-recommendation service provides product-and-services recommendations to consumers in the context of buyers' guides and other such specific information services and, at the same time, collects consumer data from the consumers that interact with the consumer interface. The consumer data is used by one or more research and analytics engines to provide a wide variety of different types of market-research results to business and commercial clients through the client interface. In other words, the current application is directed to a combined product-and-services recommendation service and market-research engine that provides services and information both to consumers seeking product information and to business and commercial clients seeking information about consumers' preferences, desires, and interests in order to inform business and commercial activities, decisions, and strategies.

In the following discussion, the terms “consumer” and “consumers” refer to individuals seeking product information by using a product-and-services recommendation service provided by a DP system and the terms “client” and “clients” refer to business and commercial clients seeking market-research information and analytical results by using a market-research and analytics service provided by the DP system. The phrase “dual-purpose automated system,” and the corresponding abbreviated phrase “DP system,” refer, in the following discussion, to a disclosed class of dual-purpose automated systems that each provides both a product-and-services consumer-recommendation service through a product-and-services consumer-recommendation-service interface (“consumer interface”) and a market-research-and-analytics service through a market-research-and-analytics interface (“client interface”). To be clear, the currently disclosed DP systems provide product and services information through the consumer interface to consumers and market-research information and analytical results through the client interface to clients.

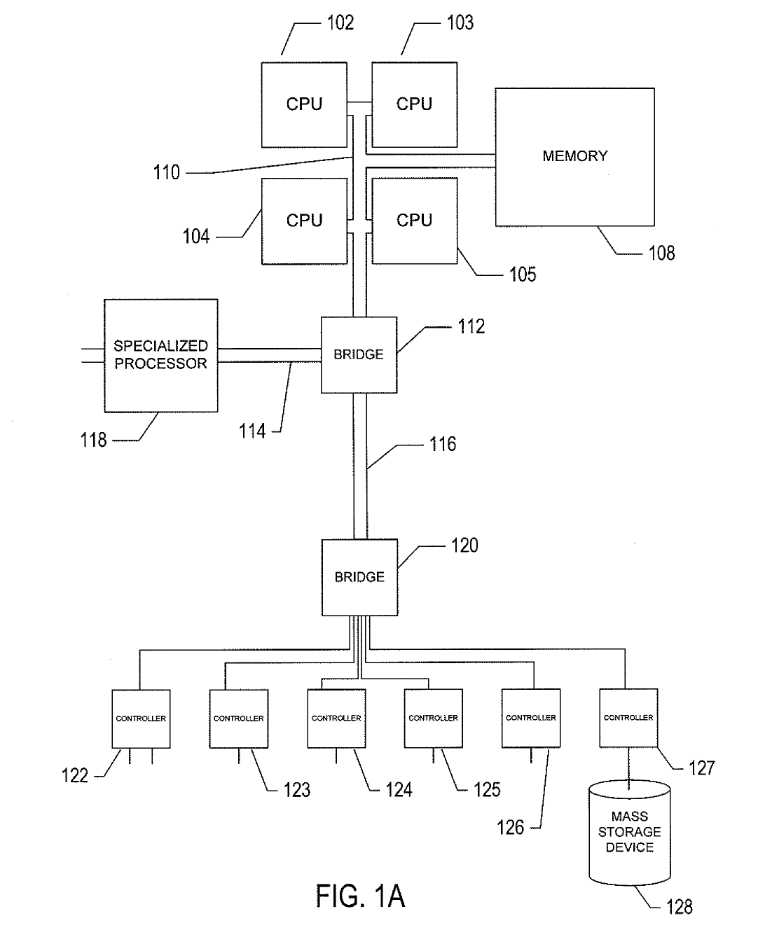

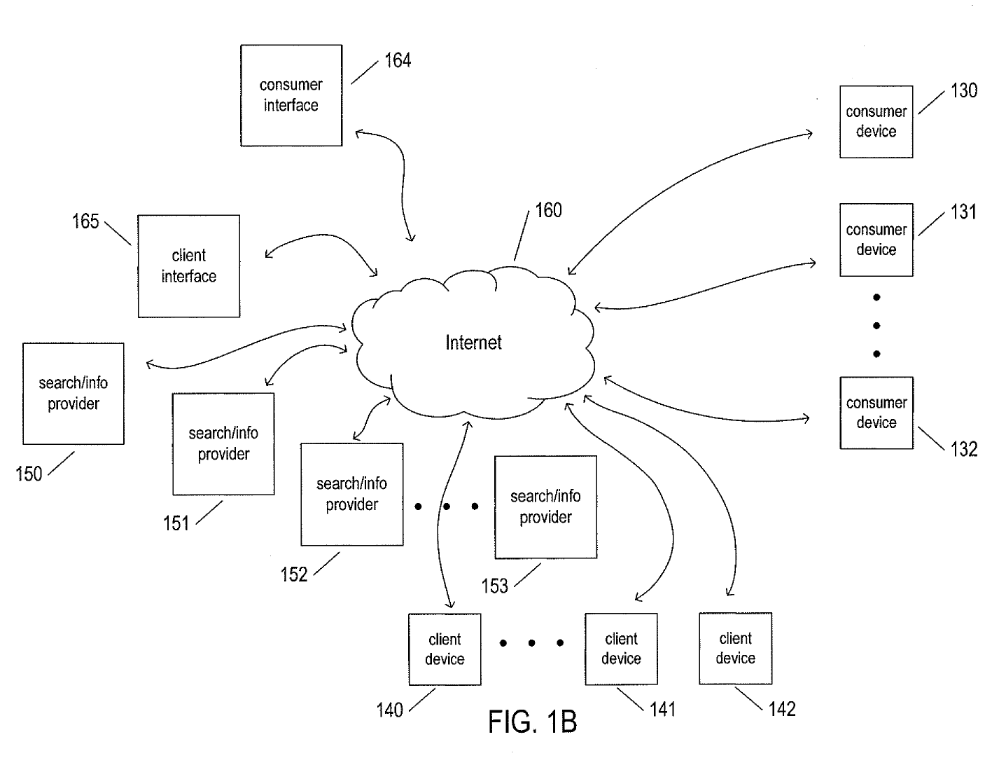

FIGS. 1A-B illustrate example system-hardware environments. FIG. 1A shows a high-level architectural diagram for a generalized computer system, including server computers, back-end computers in cloud-computing facilities, personal computers, and various types of mobile computing devices. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources, including peripheral devices that allow data to be stored and retrieved from various different types of computer-readable media, such as compact disks, DVDs, magnetic data-storage media, and other such physical, transportable data-storage media.

FIG. 1B shows a computational environment in which one example DP system operates. Consumers using consumer devices 132 and clients using client devices 140-142 both access a variety of different remote computational systems, including various search-engine and information-providing websites served by a variety of different servers 150-153 through the Internet 160. Consumer and client devices may include personal computers, various mobile computing devices, including laptops, netbooks, smart phones, tablets, and larger-scale computer systems accessible to consumers and clients through various types of computational interfaces. The currently disclosed DP system includes the above-discussed consumer interface 164 and the above-discussed client interface 165 which, in certain implementations, are websites served by one or more server computers that may be interconnected with one or more back-end computers and data-storage systems. In certain implementations, both the consumer interface and client interface may be served from a single computer system. In other cases, the consumer interface 164 and client interface 165 may be served from different virtual servers in a cloud-computing facility. In certain implementations, a single computer system may host both the consumer interface and client interface as well as carry out back-end processing, including data storage, research analysis, and acquisition, storage, and provision of product information.

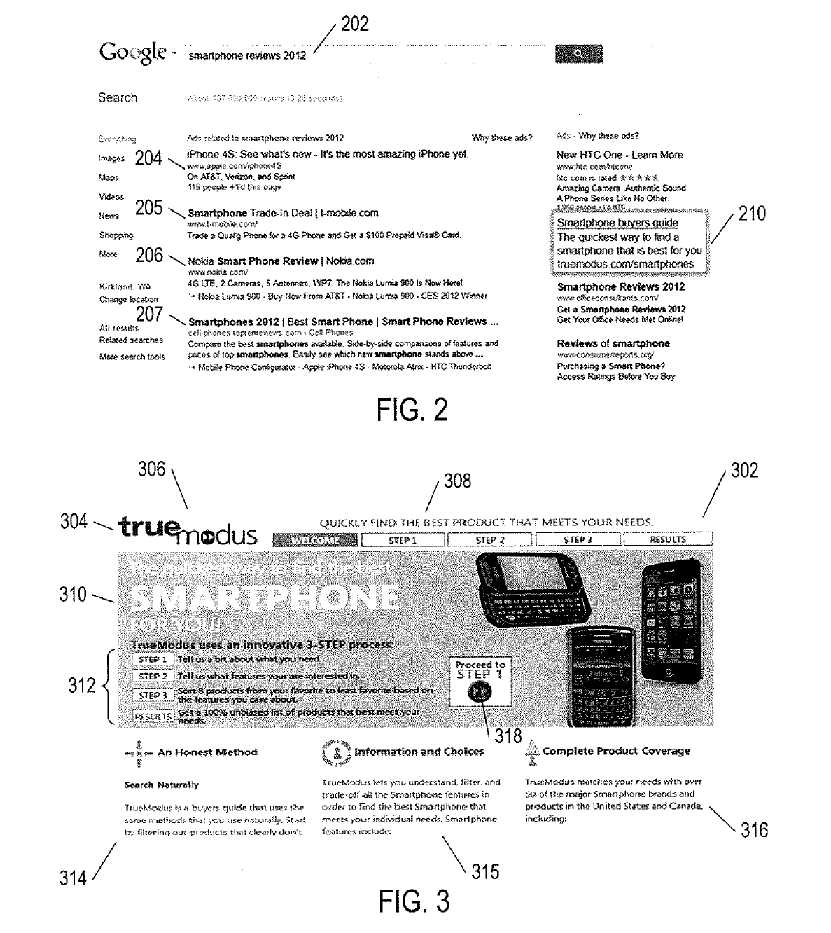

FIGS. 2-7 illustrate an example of a consumer interface through which consumers obtain product information from a dual-purpose automated system. As shown in FIG. 2, a consumer may become aware of the product-and-services consumer-recommendation service provided through the consumer interface during an Internet search for a particular type of product. In the example shown in FIG. 2, a consumer has used a popular search engine to search for reviews of smart phones 202. In addition to listing links to various reviews 204-207, the search engine also displays a link 210 to the consumer interface provided by a DP system. Upon selecting or invoking this link 210, the consumer navigates to a landing page of the consumer interface, shown in FIG. 3. In the example shown in FIG. 3, the landing page 302 is tailored to introducing a buyers' guide for smart phones, the product a consumer was searching for via the search engine. In certain implementations, a different landing page is provided by the consumer interface for each different type of product type supported by the DP system. In other implementations, the landing page may provide links to various different buyers' guides for different types of products. In yet additional implementations, a set of hierarchically organized landing pages may allow a consumer to navigate from broad product categories to particular product types and buyers' guides associated with the particular product types.

In the following discussion, it is assumed that the consumer has either directly reached a product-type-specific landing page, such as that shown in FIG. 3, directly from a link in another web page, such as a search-engine web page, or has navigated through one or more initial landing pages to a product-type-specific landing page, such as that shown in FIG. 3. The phrase “landing page,” in the following discussion, refers to a product-type-specific landing page associated with a particular buyers' guide or product-recommendation service.

The landing page is designed to orient a consumer to a process, incorporated in the consumer interface, for obtaining product information. During the process of receiving the landing page, the DP system acquires information from the consumer, including, in certain implementations, the consumer's IP address, a reference to the web page or web site that included the link through which the consumer reached the consumer interface, the search string input by the consumer that resulted in display of the link to the consumer interface, in the case that the link was provided in a search-engine web page, and other such information. The consumer is assigned a session ID by the DP system upon accessing the landing page, and the session ID is used, by the DP system, to maintain and manage a consumer-interface session, described below, that involves multiple interactions of the consumer and DP system that lead to provision of product information to the consumer as a result of a buyer's-guide service provided through the consumer interface by the DP system. The landing page includes a header section 304 with a buyer's-guide logo 306 and a progress bar 308 that uses highlighting to indicate a consumer's progress through the consumer interface towards receiving desired product information. The landing page indicates the type of product to which the buyers' guide is directed 310 and provides a description of the steps, or process, that a consumer carries out 312 in order to obtain desired product information. The landing page, in certain implementations, provides additional information 314-316, and provides an input feature 318 to allow a consumer to proceed to a next step in the process of seeking product information.

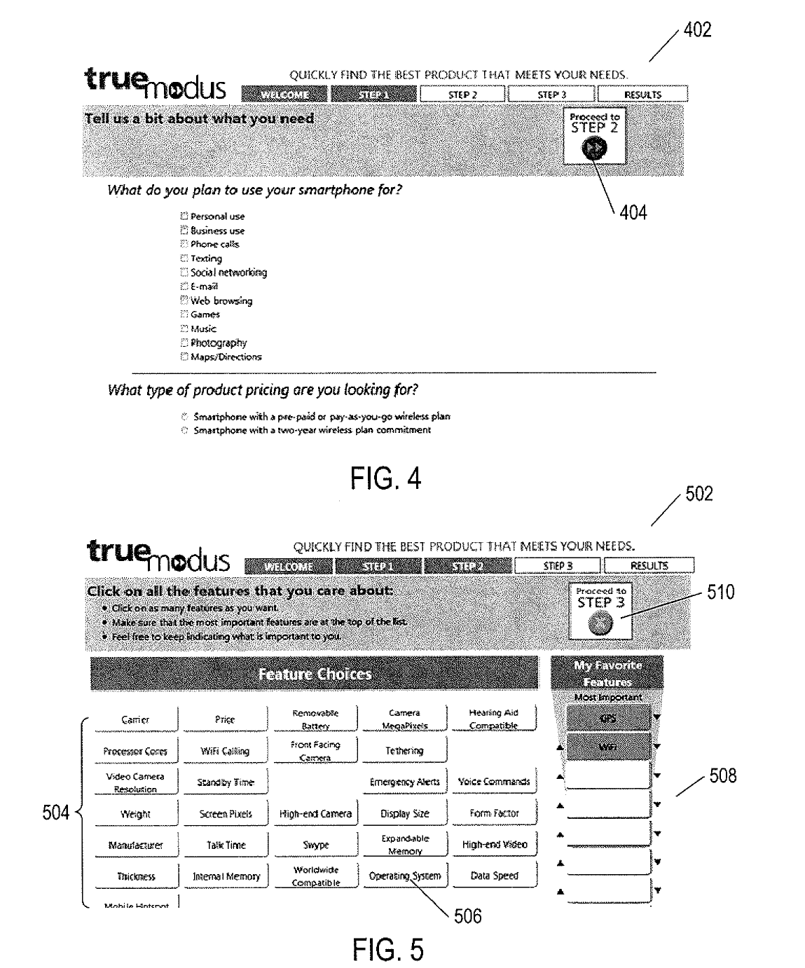

FIG. 4 shows a profile page 402 displayed to a consumer when the consumer inputs a mouse click or other such input to input feature 318 of the landing page, indicating a desire to interact with the consumer interface in order to obtain product information. Please note that, in the following discussion, the term “feature” is used in two different ways. A product feature is an attribute of a product, such as color, cost, service provider, operating system, etc. An input feature is a portion of a displayed web page to which a user inputs mouse clicks, text from a keyboard, or other types of inputs, and a display feature is a portion of a displayed web page that displays particular information to a user. The profile page, also referred to as a “consumer-information page,” is used to collect information about the consumer and the consumer's desires, interests, and preferences. The profile page may seek various types of demographic and psychographic information from the consumer, such as age, gender, income level, and other such information. The profile page may additionally seek information about the types and subtypes of products for which the consumer is seeking product information. The profile page additionally includes an input feature 404 to allow the consumer to proceed to the next page in the buyers' guide once the user has responded to various questions posed to the consumer in the profile page. In certain cases, consumer response to a particular question may be optional and, in other cases, may be required in order for the consumer to proceed. In certain implementations, multiple sequentially or hierarchically organized consumer-information pages may be provided.

FIG. 5 illustrates the feature-selection page displayed to a consumer following input, by the consumer, of a mouse click or other input to the input feature 402 of the profile page shown in FIG. 4. The feature-selection page 502 allows a consumer to select and prioritize a number of product features or feature/feature-value pairs most important to the consumer that are associated with products of the product type about which the consumer is seeking product information. The feature-selection page 502 provides input features for selection of various different product features that may be associated with products of the product type 504, such as the input feature 506 corresponding to the product feature “operating system,” and a selected-feature display feature 508 that allows a user to select and prioritize up to a maximum number of product features that are used by the DP system to evaluate products of the product type and return product information to the consumer. The example selected-feature display feature 508 in FIG. 5 displays selected product features in order of their priorities. In certain implementations, a consumer is free to select any possible subset of product features in order to direct the DP system to search for relevant products. In other implementations, the DP system continuously re-evaluates the available set of products defined by product-feature selections already made by the consumer, graying out, or disabling, product-feature-selection input features that correspond to product features that are not associated with any products in the available set of products defined by the already-selected product features. In the former case, the consumer is provided wide latitude in describing desired products, including the latitude to describe desired products that are currently not available, while, in the latter case, the consumer is constrained to select product features that together describe a set of actual, available products. Between these two extremes, intermediate feature-selection constraints may be applied in other implementations. For example, the DP system may gray out features, as described above, based on already-selected product features, but nonetheless allow a consumer to select grayed-out features. As another example, the DP system may allow a consumer to select up to some maximum number of grayed-out, or hypothetical, features, in additional to features associated with actual products. As discussed further, below, in addition to prioritizing features, the feature-selection page may allow a consumer, in certain implementations, to indicate features or feature/feature-value pairs that are always associated with products desired by the consumer or that are never be associated with products desired by the consumer. The former are referred to as “must-have,” “mandatory,” or “always” features and the latter are referred to as “can't-have” or “never” features. In certain implementations, a consumer is not permitted to input a mouse click or other input to input feature 510, in order to proceed to a next step in the buyer's-guide process, until a consumer has specified at least a threshold minimum number of features, and, in certain cases, the consumer may be required to select a minimum number of conjoint product features, discussed further below. In many implementations, in order to facilitate successful completion of the buyer's-guide process by consumers, the consumer is constrained to select no more than a maximum number of features. For example, a feature-prioritizing and feature-selection facility display feature 508 may contain only a maximum number of slots for entering features or feature/value pairs.

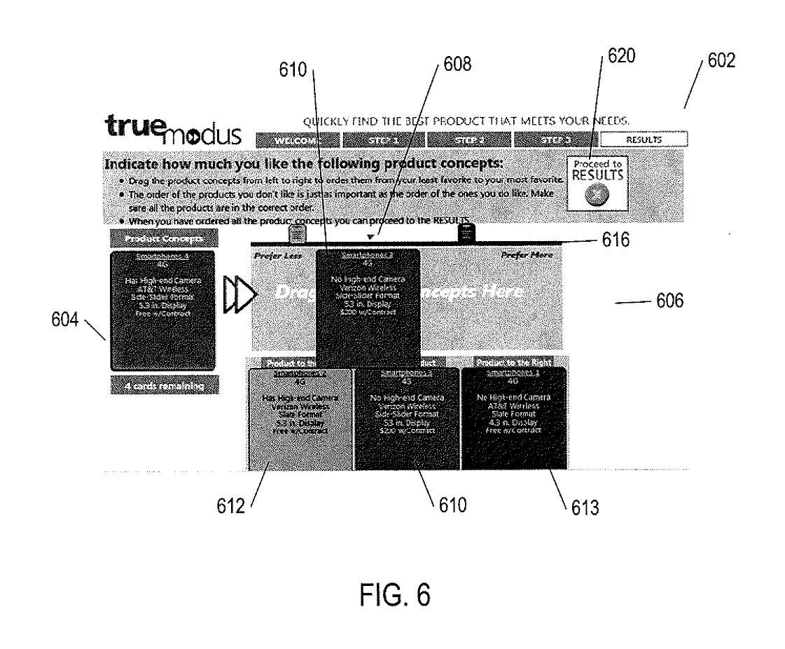

Once a consumer has selected a number of features and/or feature-value pairs suitable for continuing the buyer's-guide process, the user may input a mouse click or other input to input feature 510 in order to proceed to the product-ranking page. FIG. 6 illustrates an example product-ranking page of a consumer interface provided by a DP system. The product ranking page 602 provides a set of product descriptions 604 to the consumer as well as a product-ranking feature 606 to allow the consumer to rank the products described by the product descriptions 604. As one example, the set of product descriptions 604 may include eight different product descriptions stacked one over another like a stack of playing cards, and the product-ranking facility 606 may allow the user to remove, one at a time, each product description and place it in a linearly ordered sequence of product descriptions, the linear order representing the consumer's ranking of the products. In certain implementations, the linear ordering may imply highest-to-lowest rankings from left to right. In other implementations, other orderings or layouts may imply product rankings, and in yet additional implementations, a user may be provided input windows to specifically associate rankings with product descriptions. In certain implementations, consumers are requested to carry out a series of choices between two or more products. In the particular product-ranking facility 606 shown in FIG. 6, a consumer slides a top product description from the stack of product descriptions 604 to a position 608 with respect to already-ranked products, or to a first position in the case that no product descriptions are yet ranked. The currently considered product description 610 is shown, below the linear ordering of product descriptions, with any adjacent, already considered product descriptions 612-613 at the position to which the currently considered product description 610 has been positioned 608 in the linear ordering of product descriptions represented by the horizontal line 616 in order to assist the consumer in sliding the currently considered product description to a proper position relative to other already-ranked product descriptions. Many different types of product-ranking features may be used, with additional features provided to allow a consumer to re-rank, or edit, rankings until the consumer establishes a product-description ranking that reflects the user's preferences, desires, and interests. The stack of product descriptions 604, as discussed further below, are created by the DP system to provide a sound, unbiased, and mathematically complete experiment that allows the DP system to determine statistically meaningful coefficients for each of a set of conjoint features of the product features selected by the consumer by interacting with the feature-selection page shown in FIG. 5. As discussed further, below, the selected product features are partitioned by the DP system into a set of filter features and a set of conjoint features. In general, the filter features are used to select a subset of available products and the conjoint features are evaluated, by the consumer's product rankings, to determine the importance or significance of each of the conjoint features to the consumer. Once the consumer has ranked the product descriptions furnished to the consumer, the consumer inputs a mouse click or other input to input feature 620 in order to obtain a display of products determined by the DP system to be most compatible with the consumer's preferences, desires, and interests, determined from the consumer's feature selections and product rankings.

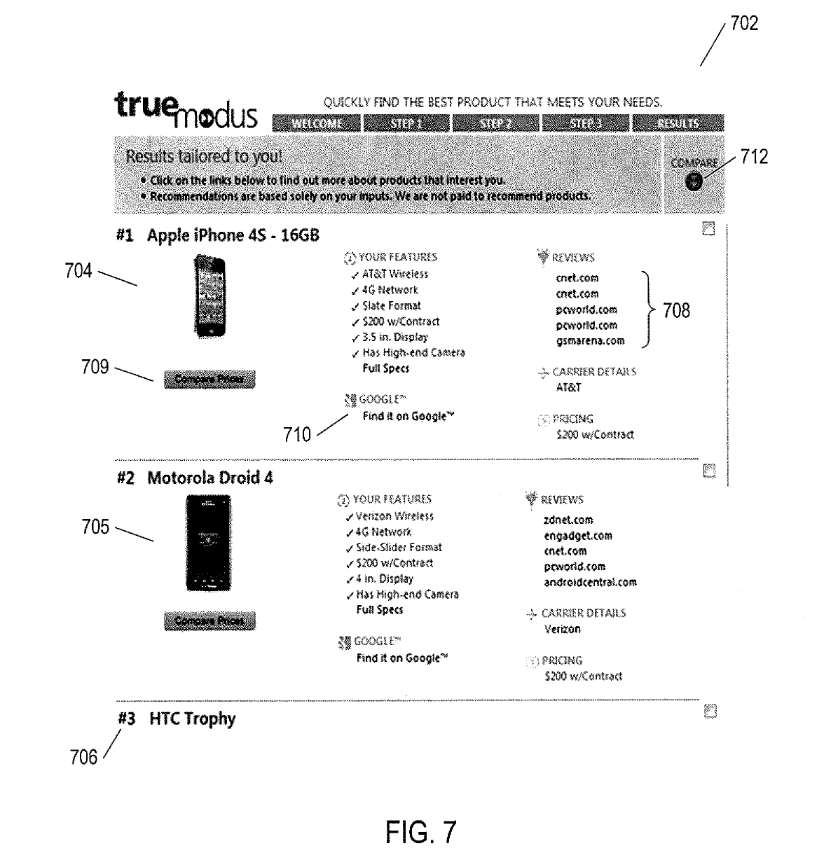

FIG. 7 shows the product information page, or results page, provided to a consumer by the buyer's-guide process. In general, the results page 702 lists, in most-desirable-to-less-desirable order, actual products corresponding to the consumer's preferences, desires, and interests as expressed in the consumer's product-feature selections and product rankings. In the example results page shown in FIG. 7, three different smart phones are described 704-706 that best meet the consumer's preferences, desires, and interests. The results page may be scrolled to reveal additional products, or may include additional product information to which the consumer may navigate, such as a set of sequential pages that each displays some number of products from the list of desirable products. In general, information displayed for a product includes links, such as links 708 for the product description 704, to allow a user to obtain additional information about the product. Additional links 709-710 allow the consumer to obtain additional information about the product or information that relates the product to other products of the same product type. In certain implementations, a user may input a mouse click or other input to an input feature 712 that provides comparisons of multiple products on one page, to facilitate comparisons of the different products. In certain implementations, various other types of input features may be provided to collect various other types of feedback from the consumer, including indications of the consumer satisfaction with a particular product, dissatisfaction with a product, level of interest in the product, and other such information.

In many implementations, once a user has viewed and interacted with the results page, the consumer may navigate back to the beginning of the buyers' guide or to the beginning of another buyers' guide in order to continue acquiring product information. As with any type of computational interface, the consumer interface may employ any of many different types of input features, information organizations, orderings of pages, and other such variations. The consumer interface may be implemented in many alternative implementations by varying any of many different design and implementation parameters, including programming language, hardware platform, operating system, modular organization, data structures, control flow, and other such design and implementation parameters.

It should be noted that the consumer interface, such as the client interface, described below, is a tangible component of the DP system. While the consumer and client interfaces may be implemented using computer instructions stored within physical instruction-storage devices, including electronic memories and mass-storage devices, that can be accessed by computational machinery in order to furnish instructions to processors for execution, these interfaces are no less physical and tangible components of the DP system than processors, mass-storage devices, electronic memories, and other such hardware components. Occasionally, one encounters opinions of people unfamiliar with modern science and technology with regard to instruction-implemented components of systems as being abstract or “merely software.” Such opinions do not reflect an accurate appraisal of the non-abstract, physical, and tangible qualities of instruction-implemented components. Stored computer instructions are certainly physically and tangibly manifested; otherwise, they could not be retrieved from storage and executed by processors. The consumer interface, client interface, and back-end processing components of the DP system are all physical, tangible, and necessary components of the currently disclosed DP system, as much so as hardware processors, mass-storage devices, communications transceivers, peripheral devices, power supplies, and other such components.

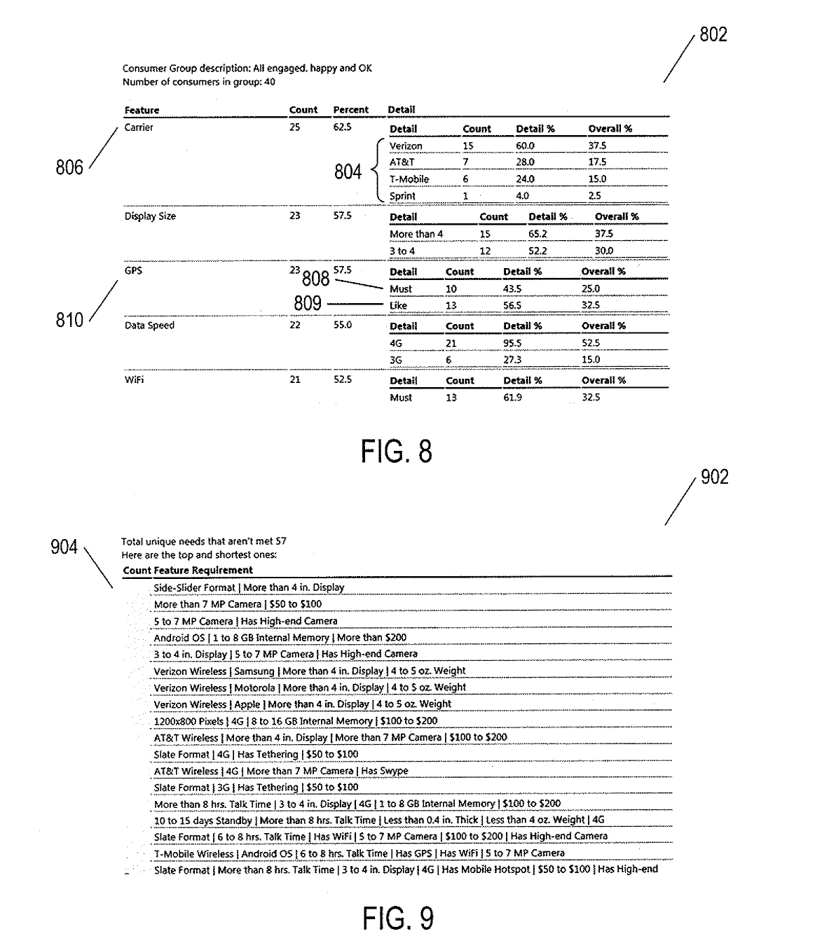

FIGS. 8-13 illustrate various example results and analyses made available to clients through the client interface of an example DP system. In general, a client first logs into the DP system through the client interface by providing authentication and authorization information, such as a name, password, and other such information. In addition, the client generally indicates a particular product type and/or specific buyers' guide or market-research test for which the client wishes to obtain market-research information and analyses. As discussed further, below, the DP system includes extensive databases and test results, client information, consumer information, products, and other types of information, based on which the DP system furnishes market-research information and analyses to clients and using which the DP system authenticates and authorizes particular clients to receive information and analyses with regard to particular buyers' guides and/or automated testing through the consumer interface. The examples shown in FIGS. 8-13 are related to a smart phone buyers' guide, the consumer interface associated with which is illustrated in FIGS. 3-7.

FIG. 8 illustrates product-feature-selection results that may be provided to a client through a client interface by a DP system. The product-feature-selection results 802 lists, in order of frequency of selection, those features associated with smart phones that have been frequently selected by consumers through the consumer interface. For features with associated feature values, such as the particular carriers 804 associated with the carrier feature 806, statistics related to consumer selections or preferences are provided within a description of the feature. Many different types and forms of product-feature-selection -associated results are possible. Product features frequently selected can be displayed or, alternatively, product features with the highest average priorities assigned by consumers may be displayed. Information related to both filter features and conjoint features may be displayed. For example, the counts of “must-have” and “like” designations 808-809 for the GPS feature 810 are displayed in the example product-feature-selection-results page shown in FIG. 8. Information may alternatively be displayed in histograms, pie charts, and other such types of information displays. Statistics related to product-feature selections provide easy-to-understand and useful information to clients respectively estimating market share and planning future products.

FIG. 9 illustrates a gap results page. The gap results page 902 lists, in order of frequency, desirable combinations of features and/or feature values, as determined from consumer product-feature selections and product rankings, that are not currently available in actual products. These hypothetical product-feature sets provide useful information to clients for future product development as well as for marketing strategies. For example, the fact that many consumers have identified a combination of a side-slider format of a large display 904 as a desirable feature set for a smart phone would strongly indicate that significant market share can be obtained by offering one or more smart-phone products with this pair of features.

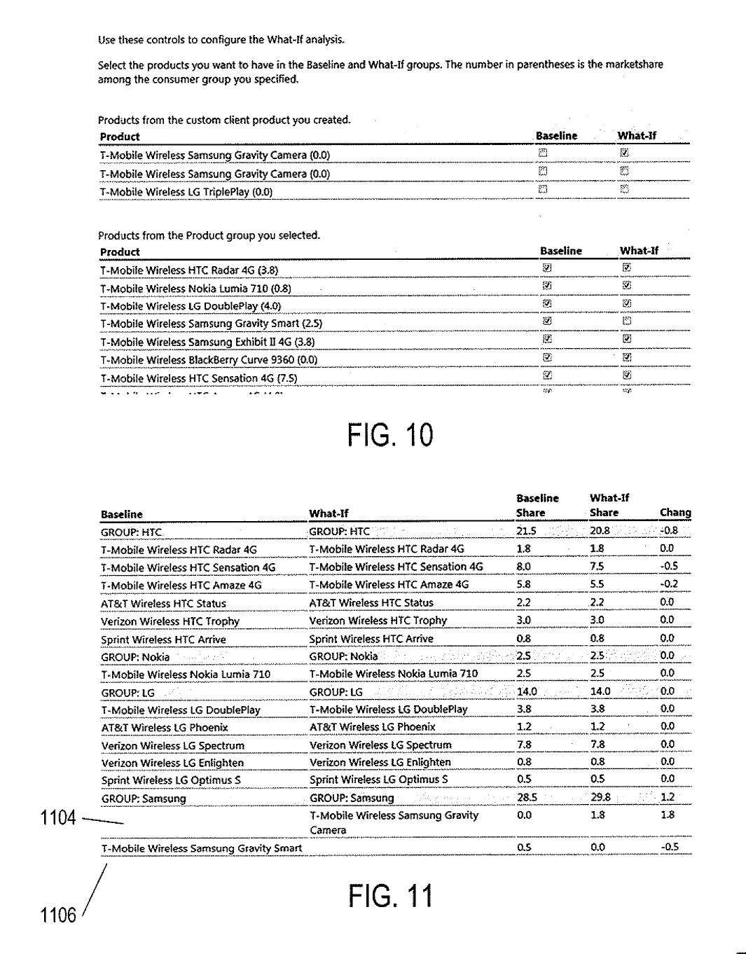

FIGS. 10 and 11 illustrate an example what-if analysis provided to a client through the client interface. In the what-if analysis, a client may create a new feature constellation that describes a hypothetical product, and then view the DP system's estimate of the relative market share of the hypothetical product with respect to currently available products. Market share is determined not only by consumer preferences, but also by many other factors, including advertising, promotions, distribution, product reliability, and other such factors, and so the estimated market shares are understood to be estimates shares of preferences, strictly speaking, by many clients. The what-if type of analyses allow a client to test, against real consumer data, the desirability and viability of new, hypothetical products and other types of hypotheses and scenarios. FIG. 10 shows a configuration page for a what-if analysis and FIG. 11 shows the corresponding results page for the what-if analysis configured in the configuration page shown in FIG. 10. In this case, a hypothetical wireless gravity camera phone 1104 is estimated to achieve a market share of 1.8 percent at the expense of a 0.5 loss of market share for the current wireless gravity smart phone 1106.

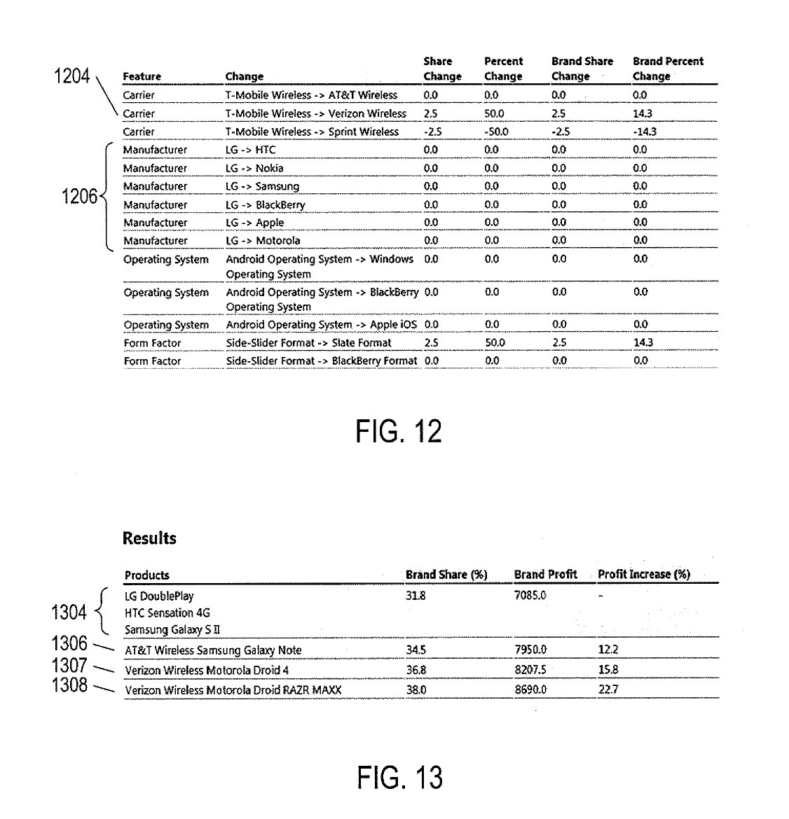

FIG. 12 shows a sensitivity-analysis results page. In a sensitivity analysis, the DP system systematically carries out what-if analyses on each product feature of a set of product features associated with an existing product to determine those product features that, when changed, may produce the greatest mobility in market share. For example, in the sensitivity analysis shown in FIG. 12, changing the carrier of a particular smart phone 1204 results in an estimated 14.3 percent change in market share, while changing the manufacturer indicates no change in market share 1206. A sensitivity analysis provides indications to clients with respect to whom product features will be most significant for future product development and/or marketing campaigns.

FIG. 13 illustrates the results of a product-lineup analysis provided through the client interface by a DP system to a client. In a product-lineup analysis, a client specifies an anchor group of products offered by the client and then requests that the DP system evaluate a series of what-if-type analyses to determine what additional products the client may offer, in addition to anchor products, which would most greatly increase market share or profit. In the example product-lineup analysis results shown in FIG. 13, the client specified three cell phones 1304 as the anchor products and the DP system determined, on behalf of the client, a product profit increase that would be obtained by successively adding three additional products 1306-1308. In this type of product-lineup analysis, the first additional product 1306 is the product that provides the greatest profit increase when added to the anchor products, the second additional product 1307 provides the greatest additional increase in profit for a product lineup including the anchor products 1304 and the first additional product 1306, and the third additional product 1308 provides the greatest additional profit increase when added to a product lineup including the anchor products 1304 and the first two additional products 1306 and 1307.

The types of analyses illustrated in FIGS. 8-13 can be provided by the DP system based on consumer-input data recorded by the DP system during interaction of consumers with the consumer interface as well as other types of stored data. A huge variety of additional types of analyses and results may also be provided using this information. As one example, a DP system can provide information regarding the demographics and response times of consumers to allow clients to select particular market segments from which to compute results and analyses by the DP system. In another example, the DP system can calculate hypothetical products for product-feature sensitivities with respect to various geographical regions or projected time periods. Of significant interest to clients is the fact that the market-research information and analyses provided by the DP system are based on information collected from real consumers supplying information with respect to actual searches for product information, and the consumer responses can be qualified and evaluated with respect to significant amounts of additional and feedback information collected by the DP system during consumers' interactions with the consumer interface.

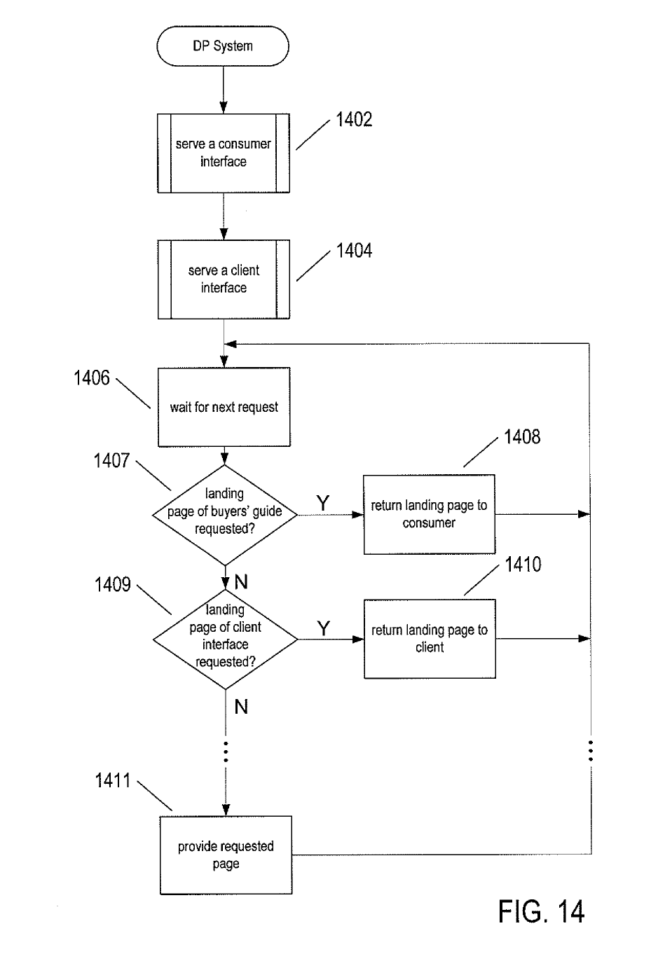

FIGS. 14-16 provide control-flow diagrams that describe high-level aspects of an example DP system. FIG. 14 illustrates high-level functionality of an example DP system. In step 1402, the DP system serves a consumer interface, a partial example of which is discussed above with reference to FIGS. 3-7. In other words, the DP system launches one or more server applications on servers that receive requests for consumer-interface pages in the context of a consumer-interface session, such as the session described above with reference to FIGS. 3-7, provide the requested pages to requesting consumers, and log information associated with consumer interaction with the web pages. The one or more servers may be stand-alone servers managed by an organization, one or more virtual servers within a private cloud-computing facility, one or more virtual servers within a public cloud-computing facility, or other such hardware configurations. In step 1404, the DP system similarly serves a client interface by launching one or more server applications on one or more servers to receive requests for client-interface pages in the context of a client-interface session, provide the requested pages, and receive and log information associated with client interaction with the client pages. As with the consumer interface, the servers that serve the client interface may be stand-alone servers, portions of stand-alone servers, or virtual servers provided by a private or public cloud-computing facility. Once the consumer interface and client interface are made available to consumers and clients, respectively, in steps 1402 and 1404, the DP system essentially executes a continuous event-handling loop, in steps 1406-1411, which show a small portion of a typical steps executed in an event-handling loop for a DP system. In step 1406, the DP system waits for a next request from a consumer or client through the consumer interface or client interface, respectively. Then, in a series of tests, such as the test represented by conditionals 1407 and 1409, the DP system determines the nature of the request and returns a web page or other information to the requester. For example, when the request is a request for a landing page of the buyers' guide, as determined in step 1407, then the DP system returns a landing page for the buyers' guide to a requested consumer, in step 1408. Similarly, when the received request is a request of the landing page of a client interface, as determined in step 1409, then the requested landing page is returned in step 1410. Of course, the event handler or various event-handler routines called from the event handler may detect a variety of error conditions, request and interactions apart from standard consumer-interface and client-interface requests and interactions, other types of events, including various system and network events, and may call event-handler routines to handle such additional types of events. A full event-handling loop of a DP system may be, as a result, relatively complex and may be implemented, in certain cases, as multiple, asynchronously operating event-handling loops. When multiple servers are used to serve either or both of the consumer interface and client interface, the DP system-event-handling loop is generally distributed among the servers. During event handling, a server may request information or computation from one or more back-end systems within the DP system, including analysis engines, product catalogs, and other such back-end systems and functionality. In general, requests from front-end servers to back-end systems are triggered from events detected and handled within the event-handling loops of the front-end servers. To summarize, a DP system includes one or more server computers that make a consumer interface and a client interface available to consumers and clients, respectively, through the Internet and continuously services various types of consumer-interface and client-interface requests received through the server computers from consumers and clients. In general, the requests are made in context of a session, such as the consumer-interface session discussed above with reference to FIGS. 3-7 or a client-interface session in which a client logs into the client interface and then requests market-research information and analyses.

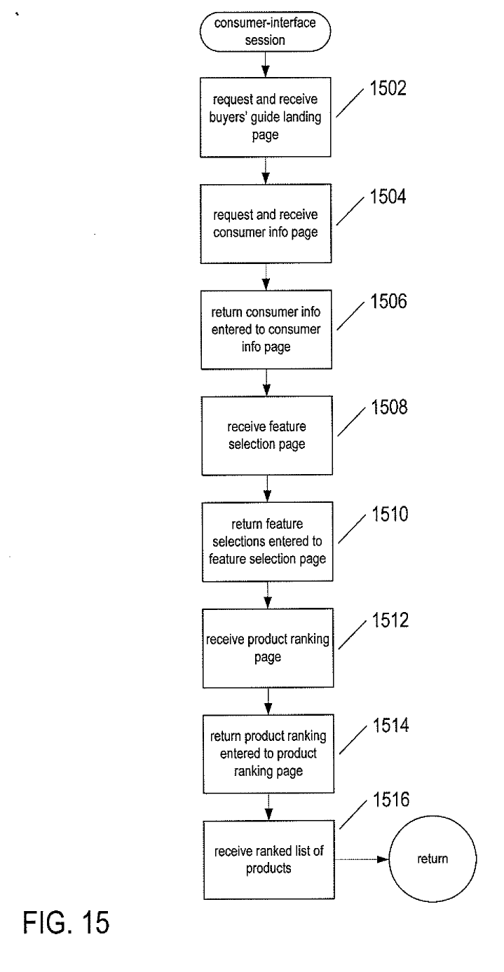

FIG. 15 illustrates, in control-flow fashion, one typical type of consumer-interface session from the standpoint of a consumer. In step 1502, the consumer requests and receives a buyer's-guide landing page. After considering the information in this page, the consumer then requests and receives the consumer-information page, or profile page, in step 1504, to begin a first phase of interaction with the buyers' guide. After providing information required by the profile page and any additional optional requested information that the consumer wishes to provide, via web-browser-based interaction with the page, the user returns the consumer-information or profile page to the DP system in step 1506. In response, the DP system sends, and the consumer receives, a feature-selection page, in step 1508. After interacting with the feature-selection page to select a number of product features and/or feature values, the consumer returns the product-feature selections entered to the feature selection page to the DP system in step 1510. In response, the DP system provides a product-ranking page to the consumer, in step 1512. After interacting with the product-ranking page to rank all described products provided by the DP system to the consumer, the consumer returns the product rankings entered to the product-ranking page to the DP system, in step 1514. In response to receiving the product rankings from the consumer, the DP system then provides a product-information page, or results page, to the consumer, who receives the page in step 1516. As mentioned above, a consumer interface may allow a user to access the same or additional buyers' guides and generally allows a consumer to request additional product information with respect to displayed products on the result page and to provide various types of feedback following step 1516.

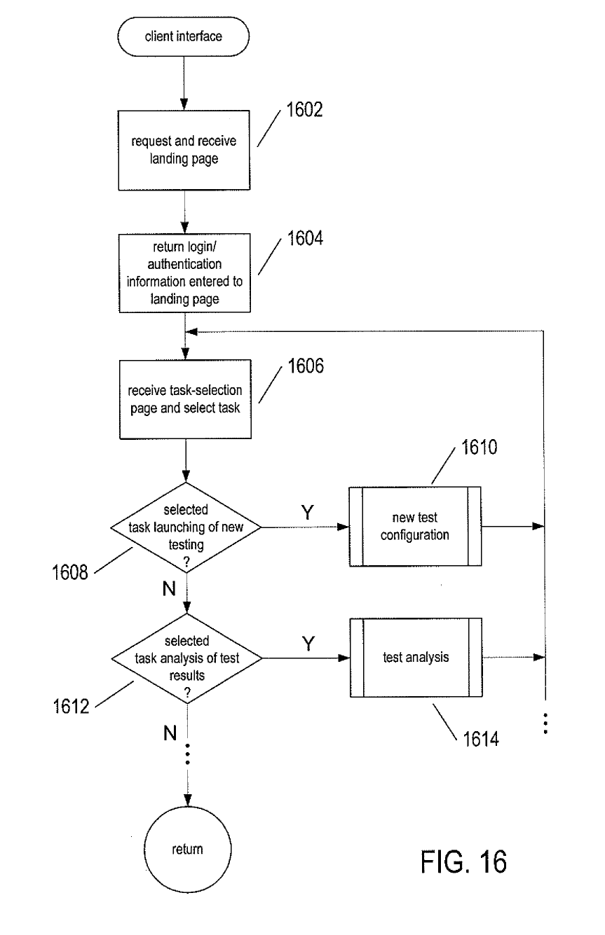

FIG. 16 provides an illustration, in control-flow-diagram form, of a typical client interface provided by a DP system from the client's perspective. In step 1602, a client requests and receives a client-interface landing page. In one example client interface, the landing page requests login and authentication information from the client which the client enters into the landing page, via the client's web browser, following which the client returns the information entered into the landing page to the DP system in step 1604. In response, the client receives a task-selection page 1606 from the DP system that allows the client to enter a task selection that is returned to the DP system by the client's web browser. Depending on the selected task, the DP system then undertakes execution of the task with provision of results to the client. For example, when the client selects a task corresponding to the launching of a new market-research test or campaign, as determined in step 1608, then the DP system provides additional web pages for collecting test-configuration information from the client in order to launch a new buyers' guide or other type of task, in step 1610. When the task selected by the client is a particular type of analysis or market-research information, as determined in step 1612, then the analysis or information retrieval is carried out and the results provided in one or more web pages to the client in step 1614. The client interface provided by a DP system generally supports many other types of task selections for clients, including segment selection and even various types of ad hoc queries that the DP system executes on behalf of the client with respect to information stored in one or more databases within the DP system.

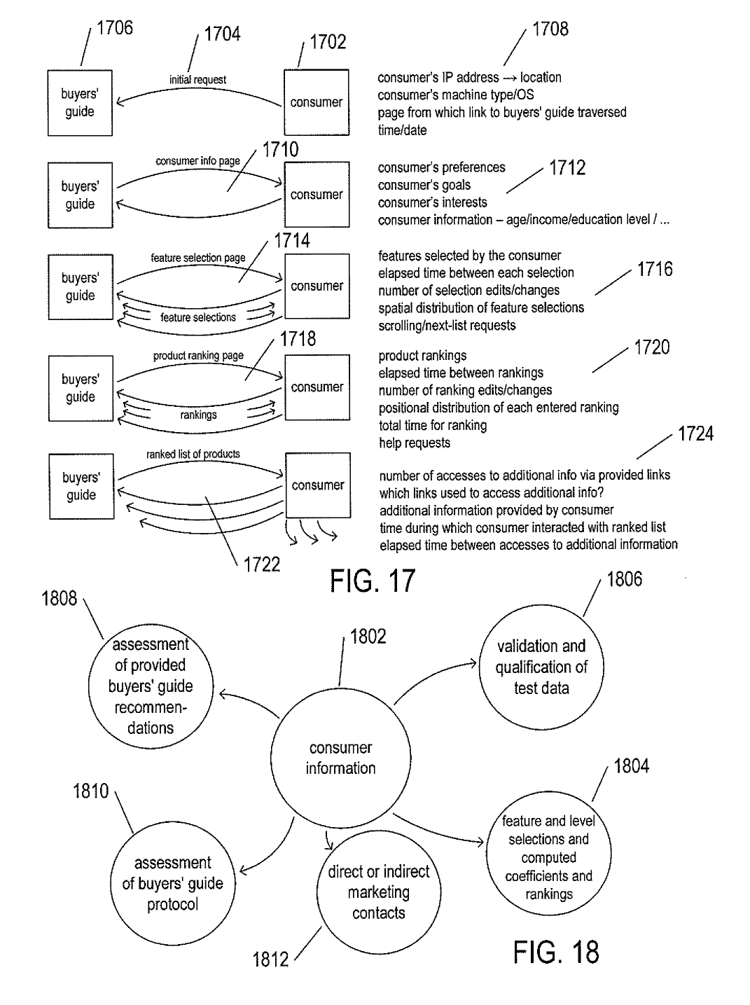

FIG. 17 illustrates many different types of information obtained from consumers during consumer-interface sessions that a DP system records for various purposes. Initially, a consumer 1702 may request a landing page for a buyers' guide 1704 from a buyer's-guide website served by a DP system 1706. In this initial interaction, the DP system may obtain a consumer's IP address and geographical location, indications of the type of device the consumer is using to receive and display web pages, including a machine type and operating-system type, an indication of the web page that contained a link through which the consumer requested the landing page, the time and date of the request, and other such initial information 1708. In a next interaction, in which a consumer receives a consumer-information or profile page and returns, to the DP system, information requested of the consumer in the consumer-information or profile page 1710, the DP system obtains, by answers supplied to the DP system by the consumer, information about the consumer's preferences, goals, interests, and profile information about the consumer, including the consumer's age, income, educational level, and other such information 1712. Next, when a transaction in which the DP system furnishes a feature-selection page to the consumer and the consumer responds by carrying out feature selections requested of the consumer 1714, the DP system obtains the consumer's feature selections and selected-feature rankings or priorities, as well as a large variety of additional consumer-interaction information related to how the consumer interacted with the feature-selection page 1716. For example, the DP system may receive and record each individual feature selection and editing operation carried out by the consumer during interaction with the feature-selection page, recording a time and date along with an indication of the type of interaction and information supplied via the interaction. This allows the DP system to compute various types of consumer-interaction information, including the lapsed time between feature selections, the number of edits and changes to feature selections made by the user during the course of selecting features, a spatial distribution of the selected features with respect to the product-feature-associated display features of the web page, the number of scrolling and other types of navigational operations carried out by the consumer during product-feature selection, the number and types of additional information, such as help information or feature details, requested by the consumer during product-feature selection, and many other types of consumer-interaction information. Similarly, following feature selection, during the product-ranking page transaction in which a consumer receives a product-ranking page and ranks a set of described products 1718, the DP system obtains not only the actual product rankings, but many different types of additional consumer-interaction information related to the consumer's interaction with the product-ranking page 1720. In fact, consumer-interaction information related to interaction of a consumer with the consumer interface may be collected and stored with respect to each of the pages of the consumer interface. Finally, after providing the product information in the results page to the consumer, various types of additional consumer interaction with the results page 1722 allow the DP system to obtain a large number of different types of feedback information, including the number of accesses made by the consumer via links provided in the results page, additional product information, descriptions of the particular links through which the consumer accessed additional product information, various types of additional feedback information explicitly provided by the consumer, including indications of satisfaction or dissatisfaction with respect to listed products, the elapsed time during which the consumer interacted with the results page as well as with individual listed-product information, elapsed time between accesses to additional information, and other types of information related to a consumer's interaction with the results page 1724.

FIG. 18 illustrates various ways that the many different types of information obtained from consumers during consumer-interface sessions, discussed with respect to FIG. 17, can be used by a DP system. The consumer information collected during consumer-interface sessions 1802 can be used to generate market-research information related to feature-selection and feature-prioritization statistics as well as computed coefficients and rankings for features and products 1804, as discussed, in greater detail, below. In addition, the DP system can use the consumer information to validate and qualify the data obtained from particular consumer-interface sessions 1806. For example, data obtained from a consumer who quickly selected a set of product features during interaction with the feature-selection page, with the average elapsed time between product-feature selections made by the consumer less than a minimum threshold value, may be rejected because the consumer appears not to have carefully considered the product-feature selections. Another example of information that may lead to disqualification of data may be, as another example, the fact that the consumer selected product features, in order, from only one row of multiple rows of display features, indicating that the consumer did not carefully consider the full array of display features prior to making product-feature selections. In certain DP systems, this type of information may be used not only to qualify and disqualify data collected from particular consumers, but may be used to differentially weight data obtained from different consumers during data analysis.

The recorded and stored consumer information may be also used by the DP system to assess the quality of buyer's-guide recommendations made by the DP system to consumers 1808. As one example, when a consumer requests additional information about the highest-ranked products, the DP system can infer that the product rankings determined by the DP system on behalf of the consumer appear to have been fairly accurate. By contrast, when a consumer selects additional information about relatively lower-ranked products, and does not request information about the higher-ranked products, the DP system may infer that the product rankings provided by the DP system to the consumer were less accurate. Inferred accuracy of the product rankings may also reflect underlying accuracy and reliability of feature coefficients and rankings computed by the DP system from the consumer information obtained during a consumer-interface session. These types of inferences may also be used for qualification and validation of test data.

The collected consumer information may also be used, by the DP system, to assess the efficiency and effectiveness of the buyer's-guide protocol or method 1810. For example, the DP system may detect patterns of relatively long elapsed times between certain types of requests made to consumers and the consumers' responses that may indicate the requests are generally ambiguous or confusing. Similarly, the DP system can identify various types of information transactions which proved generally problematic to consumers so that the buyer's-guide process can be redesigned or streamlined for greater efficiency, which generally leads to a higher percentage of session completions. This type of information may be used by the DP system to refine various parameter settings, over time, including the number of product descriptions provided for ranking in the product-ranking page, optimal or near-optimal number of products listed in the results page, and the number and types of requests made in the consumer-information, or profile, page.

Finally, the collected consumer information may, for certain organizations, provide direct or indirect marketing-contact information which can be used internally by the organization that manages the DP system or, in certain cases, provided to external organizations 1812. As one example, consumers who frequently and accurately interact with buyers' guides may be identified as potential candidates for other types of market research. As another example, consumers who accurately interact with a particular buyers' guide and express particular interest in one or more products may be identified as potential candidates for receiving various types of unsolicited product information with respect to those products or similar products.

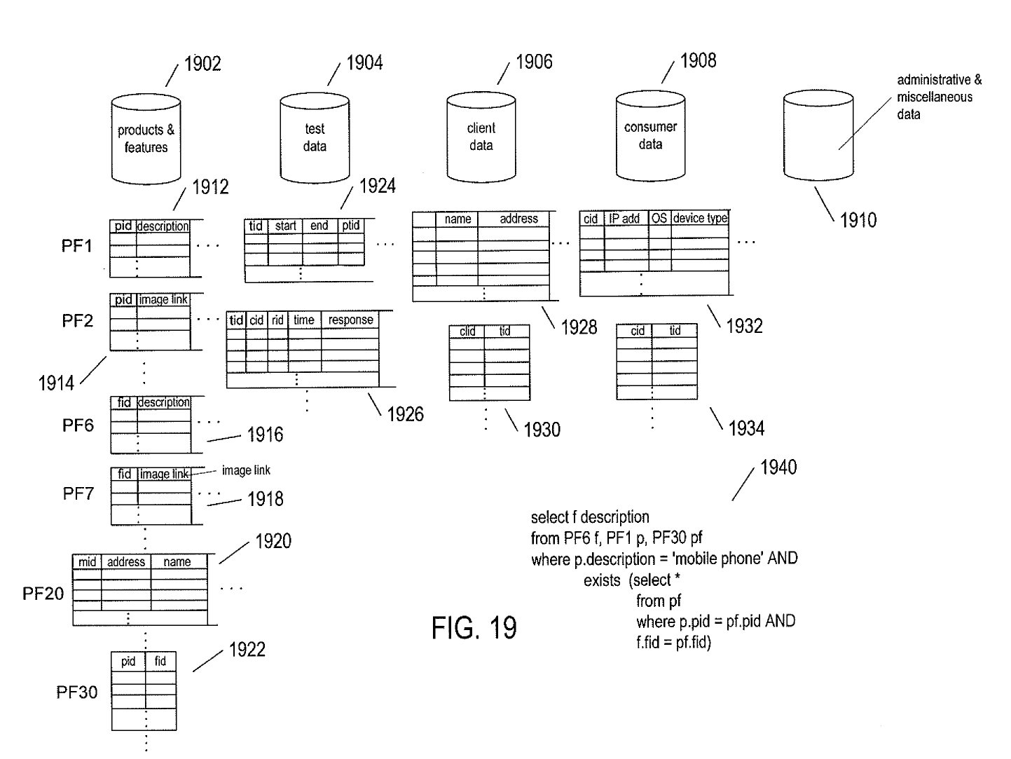

FIG. 19 illustrates the type of data that may be stored within a DP system. As one example, a DP system may include a products-and-features database 1902, a test database 1904 that stores consumer information obtained during consumer-interface sessions, a client database 1906 containing client information obtained from clients during client-interface sessions, a consumer database 1908 that stores explicit information about particular consumers, and various additional administrative and miscellaneous databases 1910. Any of many different types of database technologies may be used for storing data. FIG. 19 provides examples of various relational tables that may be defined and populated by relational-database implementations of the various databases maintained by a DP system. For example, the product-and-features database 1902 may include tables that associate a product identifier with a product description and other product information 1912, a table that associates product identifiers with links to product images 1914, similar tables that associate product-feature identifiers with product-feature descriptions and links to product-feature images 1916 and 1918, various specific-product-feature tables, such as a table 1920 that stores manufacture information associated with manufacture identifiers, and a table 1922 that associates product identifiers and product-feature identifiers or that, in other words, defines the set of product features associated with each different product. The test data database may include tables that describe particular tests 1924 by associating test identifiers with start and end times for the test, product-type identifiers, and other information, and tables that log individual consumer interactions during tests 1926 by associating test identifiers, consumer identifiers, and response identifiers with dates and times and response information received. The client database 1906 may include tables that associate client identifiers with various types of client information 1928 as well as tables that associate clients with particular tests 1930. Similarly, the consumer database 1908 may include tables that associate consumer information with consumer identifiers 1932 as well as tables that associate consumer identifiers with test identifiers 1934. Any of the databases may contain tens to hundreds of different relational tables along with various indexes, views, and other relational objects. Using relational database technology allows simple extraction of various types of computed results using a query language, such as the SQL statement 1940 included in FIG. 19 that selects the descriptions of features associated with the product type “mobile phone.” FIG. 19 is not meant to, in any way, apply a particular database technology, schema, or other detail information for use in storing DP system data, but is instead intended to illustrate the relatively large amount of different types of data that may be stored for subsequent retrieval by a DP system in order to carry out the various types of activities discussed above with reference to FIG. 18 as well as to carry out retrieval and display of market-research data and market-research analyses.

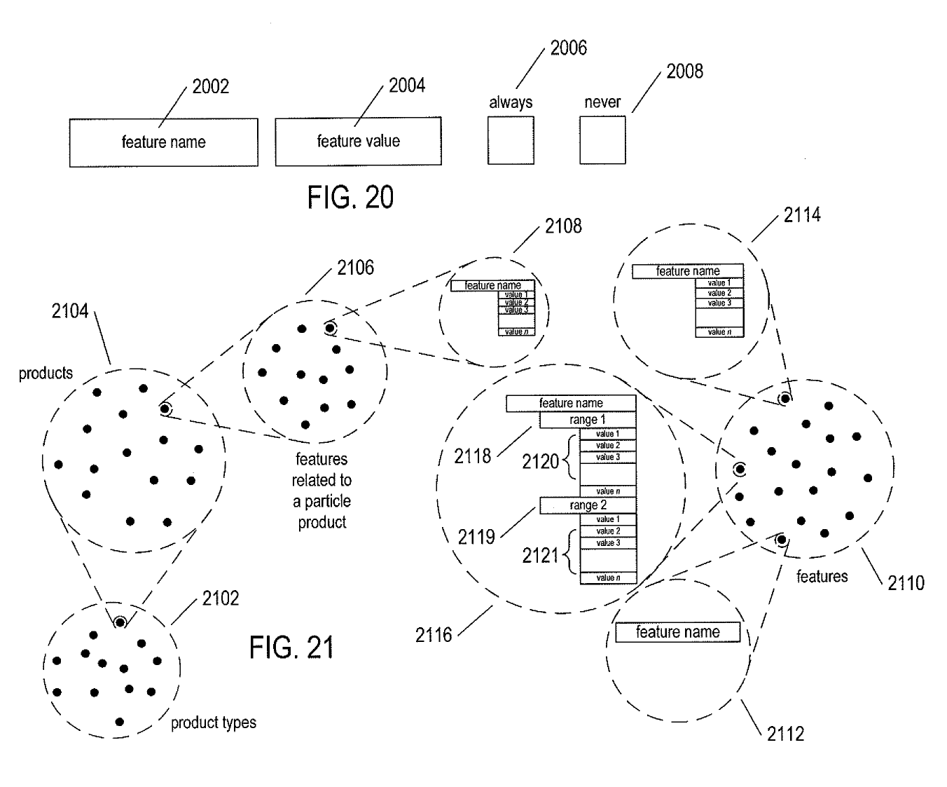

FIGS. 20-23 illustrate underlying operations carried out by a DP system during the initial portion of a consumer-interface session. FIG. 20 illustrates an example product-feature-selection input feature in which a consumer specifies a feature and information related to a feature. The name of the feature is specified by a consumer in input feature 2002. In certain cases, the consumer may also specify a value for the feature, using input feature 2004, with the combined feature name and feature value together comprising a type of derived feature that may be associated with the product. In addition, the user may indicate that the feature or derived feature must be associated with products of interest using input feature 2006 or that the feature or derived feature can never be associated with a product of interest, using input feature 2008. FIG. 20 is intended to illustrate one example of many different types of product-feature-selection input features as well as the fact that selected features may be either feature names or other identifiers, derived features that include feature names or other identifiers along with one or more feature values, or features or derived features that are additionally markets as always or never features, among others.

FIG. 21 illustrates various sets of data stored by a DP system. A DP system may store a set of product types 2102, each element of which corresponds to a distinct set of individual products 2104, as shown in FIG. 21. Each individual product in the set of products corresponding to a product type, in turn, corresponds to a set of product features 2106 associated with the individual product. There are various different types of features. One type of feature includes a feature name and a list of values associated with the feature 2108. As also shown in FIG. 21, the DP system may store a general set of product features 2110, each element of which corresponds to one of a variety of different types of features. One type of feature consists only of the feature name 2112. As an example, the feature “portable” associated with radios indicates that the radio can be easily moved and may contain a portable power source. Another type of feature 2114 includes both a feature name and a set of different values corresponding to the feature. For example, the feature “color” may have various different feature values, such as “red,” “black,” “blue,” “yellow,” “green,” “orange,” and other such values. In the case of this example feature, it is understood, in general, that a product has a color. A particular product is associated with a feature/feature-value pair that partially describes the product, such as the feature/feature-value pair “color/blue” that may be associated with a blue shower curtain as one of the collection of features and derived features used to describe the shower curtain. Yet another type of feature 2116 includes a feature name, several first-level values 2118-2119, and second-level values 2120 and 2121 associated with each first-level value. Quite often, these types of features are referred to as “range features,” where the first-level feature values describe ranges, such as price ranges, and the second-level feature values describe individual prices. It is possible that a feature may be associated with three or more different hierarchical levels of feature values. In certain cases, the second-level feature values may be implied by the first-level feature values rather than individually stored.

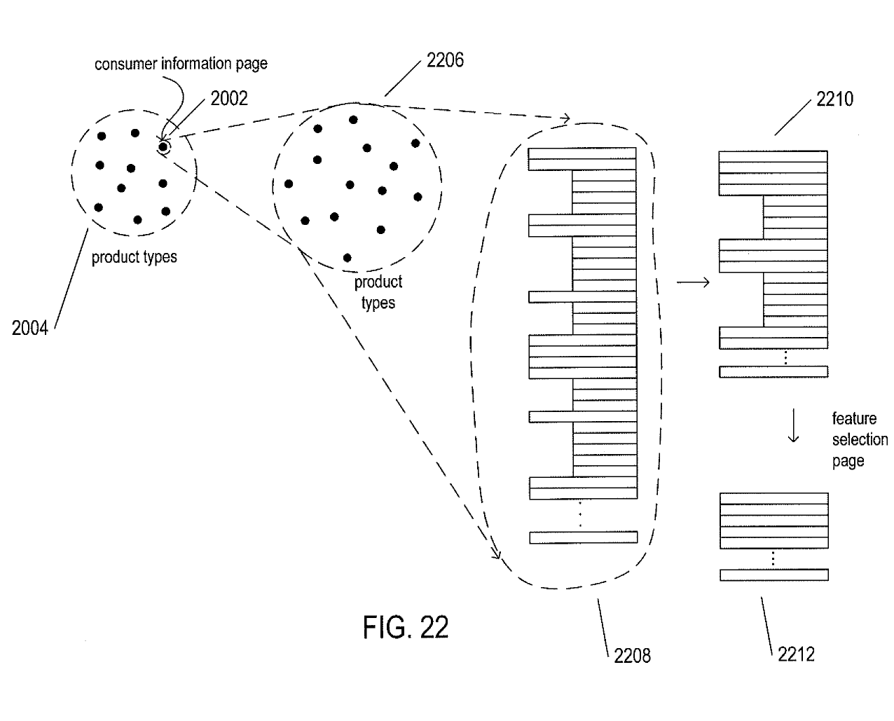

FIG. 22 illustrates, using the illustration conventions introduced in FIG. 21, initial steps in a consumer-interface session. Information returned by a consumer on the consumer-information, or profile, page is used by the DP system to select a particular product type 2202 from among the set of available product types 2204 for which the DP system is prepared to provide product information. All of the products associated with the product type 2206 are then examined to create a list of the product features associated with one or more products within the set of products associated with the product type 2208. In general, the DP system maintains, with each product feature, a count of the particular products with which the product feature is associated and, in certain implementations, additional information. These counts and additional information are used by the DP system to select a subset 2210 of the set of product features 2208 that are most likely to provide meaningful feature selection to the consumer with respect to the set of products corresponding to the selected product type 2206. For example, a product feature associated with only one particular product and that does not appear to be related to consumer preferences or goals, as determined from information supplied by the consumer in the information page, is generally less valuable than product features associated with at least some threshold percentage of the products within the set of products 2206. Many other considerations may be applied in order to select a reasonable set of product features 2210 that can be provided, as selectable product features, on the product-feature-selection page to the consumer. The set of product features is then displayed to the consumer on the product-feature-selection page and the consumer selects a number of product features greater than or equal to a minimum number of features and less than or equal to a maximum number of features needed for soliciting meaningful information from the consumer 2212 by the DP system. In many implementations, the consumer not only selects the set of product features 2212 but, in addition, ranks the product features in importance.

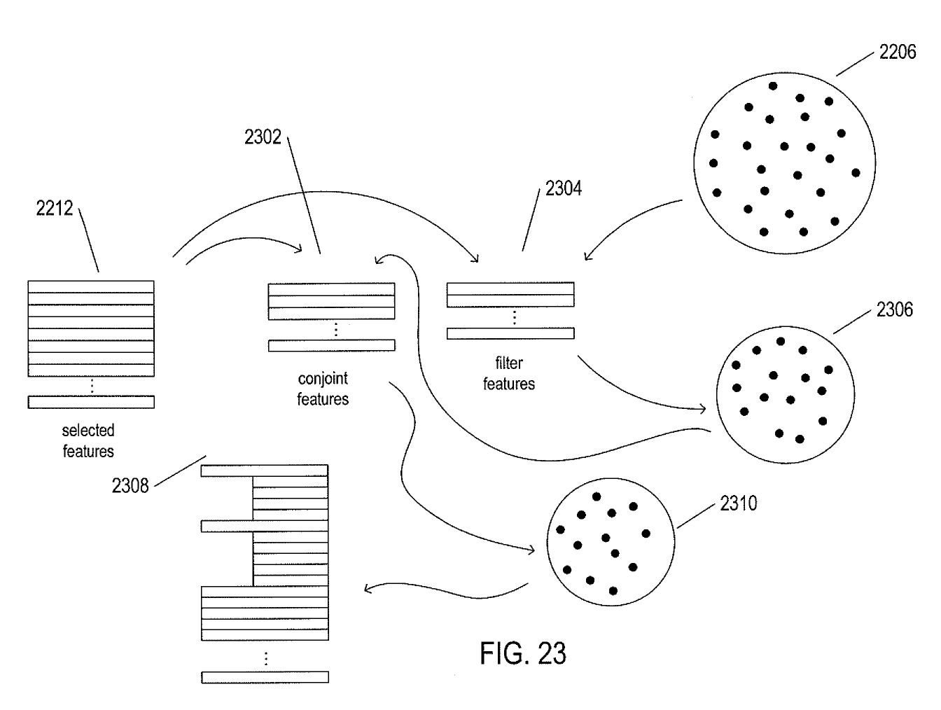

Next, as shown in FIG. 23, the DP system partitions the selected product features 2212 into a set of conjoint features 2302 and a set of filter features 2304. Filter features are features indicated by the consumer, using inputs to the always and never input features (2006 and 2008 in FIG. 20), to be always or never features. Filter features 2304 are used to filter the entire set of products within a selected product type 2206 to produce a subset of products 2306 that are each associated with indicated must-have features and that are not associated with cannot-have features. The subset of products 2306 obtained by filtering the initial product set 2206 using the filter features is then used to re-evaluate the conjoint features 2302. Following filtering, it may be the case that a conjoint feature, multiple values of which were associated with multiple products in the original product set 2206, is not associated with, or only one value of which is associated with, products in the subset of products 2306. For example, had a consumer selected a cost feature with three different cost-range values, and, after filtering, only low-cost products remain in the filtered subset 2306, then the DP system may choose to remove the cost feature from the conjoint features 2302 or replace derived features that include the first-level feature values with derived features that include the second-level feature values or, in other words, use actual prices of products rather than cost ranges when the remaining products in the subset are associated with a reasonable distribution of different prices within the low-cost range. In certain cases, when the cardinality of the subset of products 2306 following filtering falls below a threshold value, the DP system may adjust the set of filter features 2304 and then again carry out filtering in order that the product subset 2306 has a sufficient number of members. Similarly, when re-evaluation of conjoint features 2302 results in a number of conjoint features falling below a minimum threshold number, the DP system may alter the set of filter features and demote must-have filter features to conjoint features in order to obtain a sufficient number of conjoint features for subsequent conjoint analysis. As discussed further, below, there are a finite set of conjoint-analysis experiments defined by the number of conjoint features and number of feature levels or values for each of the features, and the DP system generally iteratively adjusts the set of conjoint features 2302 and filter features 2304 in order to obtain a set of conjoint features with properties corresponding to a conjoint-analysis experiment and a product subset 2306 of sufficient cardinality to produce meaningful results from the consumer-interface session. At the end of this process, a list of features and associated feature values 2308 corresponding to a final product subset 2310 is determined by the DP system as the basis for subsequent conjoint analysis.

There are a variety of different statistical methods for carrying out product-ranking experiments in order to obtain statistically meaningful feature coefficients. In a default approach, all possible combinations of product-feature values that could be associated with actual or hypothetical product descriptions are supplied, as actual and hypothetical product descriptions, to the consumer for ranking on the product-ranking page. However, for even a relatively small number of features, each associated with a small number of possible feature values, the number of actual and hypothetical product descriptions greatly exceeds a practical maximum threshold number of product descriptions for ranking by individual consumers. In alternative techniques, a carefully chosen subset of all possible combinations of features and feature values is used to generate actual and hypothetical product descriptions, so that the number of product descriptions that a consumer is asked to rank falls within a reasonable numeric range while, at the same time, the various feature levels are well distributed in the product descriptions so that feature coefficients derived from subsequent conjoint analysis are statistically meaningful. One specific approach for design of experiments of this nature is referred to as “orthogonal arrays.”

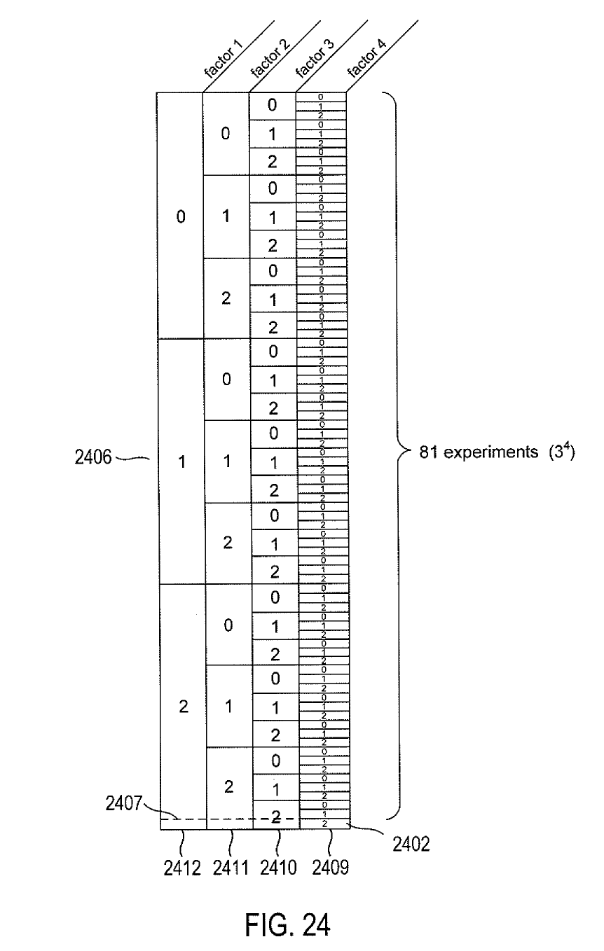

Consider the problem of designing an experiment in which the effects of four different variables, or factors, are desired to be ascertained. One way in which to design an experiment to test the effects of the four factors is to carry out an exhaustive, combinatorial experiment in which each of all possible combinations of the three different variations for each factor are tested, over a period of time. FIG. 24 illustrates a full combinatorial experimental design for a four-factor experiment. In FIG. 24, each small rectangle, such as small rectangle 2402, in the right-most column 2404 of the displayed table 2406 represents a different combination of factor values, or factor levels, which, in a full combinatorial experiment, may constitute a separate actual or hypothetical product description. For example, small rectangle 2402 indicates that the third level, where the levels for the factors are numerically designated {0,1,2}, for factor 4 is used in the product description represented by that rectangle 2402 and corresponding values for the other three factors shown in regions of the table collinear with that rectangle. The levels for the remaining factors are indicated at the same horizontal level within a table. For the final product description, which includes level 2 for factor 4, the remaining factors also have level 2, since expanding the small rectangle 2402 leftward, as indicated by dotted line 2407, overlaps regions of columns 2410-2412, representing factors 3, 2, and 1, respectively, indicated in table 2406 to have the value 2. A full combinatorial experiment comprises a total of 3⁴, or 81, separate product descriptions. Thus, in order to carry out the combinatorial experiment, one might either proceed sequentially, down the table, selecting values for each of the factors from each row of the table to specify each successive product description, or randomly select product descriptions from the table.

By using a full combinatorial experiment, it is possible to statistically analyze the data in order to determine the effects of all different factors, considered alone, on the experimentally-determined results as to determine the joint effects of all possible pairs and triplets of the four factors. As one example, given that a factor 4 presents the color of a product, with levels 0, 1, and 2 representing the colors red, blue, and green, experimental analysis of the results obtained from a full combinatorial experiment may reveal that consumers are twice as inclined to order a red product. Additionally, the experiment may reveal that, with factor 3 representing cost, that a low cost combined with the color red most effectively motivates consumers to order the product, while, in general, higher costs are more effective when combined with colors other than red. Such interdependencies between factors are referred to as “factor interactions,” or simply as “interactions.”

While a full combinatorial experiment is easily designed, and provides complete support for subsequent statistical analysis, a full combinatorial experiment design is often infeasible. The number of product descriptions grows exponentially with respect to both the number of factors and the number of factor levels. In a larger, many-factor and many-factor-level version of the above example, a full combinatorial experiment design may require rankings of an enormous number of actual and hypothetical product descriptions. Therefore, experiment designs generally feature only a subset of the total possible product descriptions. For example, in the experiment-design problem discussed with reference to FIG. 24, above, a practical experiment design may use only ten or less of the possible 81 product descriptions for an experiment that tests four different 3-level factors.

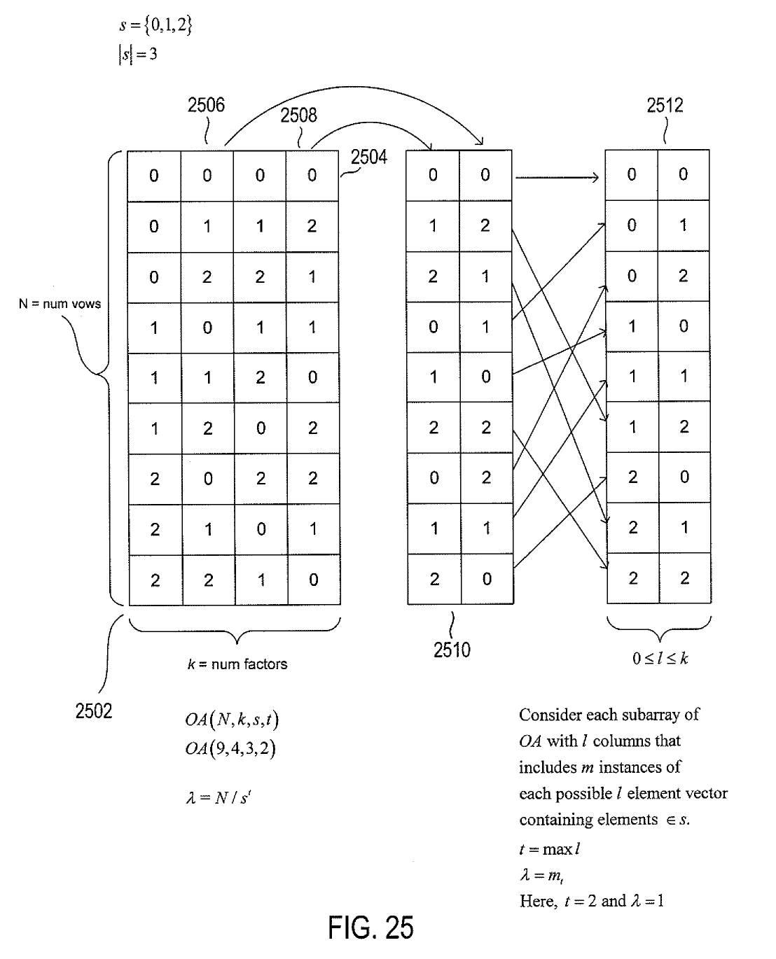

Orthogonal arrays have been developed for experiment design to systematically select, as an experiment design, a subset of all possible examples or test runs for a particular number of factors and levels. The subset is selected to provide results that can be efficiently, robustly, and reliably analyzed to determine the independent effects of factors as well as specified interdependencies between factors, or interactions. FIG. 25 illustrates an orthogonal array that can be used as the experiment design for a four 3-level factor experiment, a full combinatorial experimental design for which is shown in FIG. 24. In FIG. 25, the orthogonal array 2502 is a 9×4 matrix, or two-dimensional array, in which each of the rows represents a product description, each of the columns represents a factor, and the numbers in each cell of the matrix represent a particular level, or value, for a particular factor within a particular test run. For example, in orthogonal array 2502, the first row 2504 represents a product description in which the level, or value, for all four factors is 0. Again, factors are variables in the experiment, and the levels are numeric representations of different values that a factor may have. In pure orthogonal arrays, all factors have the same number of levels. In mixed orthogonal arrays, the number of levels associated with factors may vary.

Orthogonal arrays have a number of interesting properties. FIG. 25 illustrates one of these properties. In general, in an orthogonal array, there is an integer t that specifies a maximum number of columns that can be selected from the array such that a sub-array containing only the selected columns includes a fixed number of all possible t-tuples. For example, in FIG. 25, by selecting columns 2 2506 and 4 2508 to form subarray 2510, and permuting the rows of the subarray to produce the ordered subarray 2512, it can be observed that each possible two-element tuple, or vector, for three levels is represented as a row in the ordered subarray 2512. Any two columns selected from the orthogonal array include all possible two-tuples. The value of t may range from 1 up to k, the total number of columns in the orthogonal array.

An orthogonal array can be represented using various different notations. In one notation, the orthogonal array is represented as:

OA(N,k,s,t)

where N=number of rows;
k=number of columns;
s=number of levels;
t=maximum number of columns that can be selected to form a subarray containing all possible t-vectors as rows.
   There is an additional parameter λ, referred to as the index, which indicates how many copies of each possible t-tuple are contained in a t-column subarray of the orthogonal array. In the example of FIG. 25, λ=1, since the ordered subarray 2512 contains a single copy of each possible 2-tuple. The parameter λ can be derived from the other parameters by:

λ=N/s^{t}\sqrt{b²−4ac}.

It should also be noted that the subarrays with numbers of columns {1, . . . t-1} also have the above-described property of the subarrays with t columns.

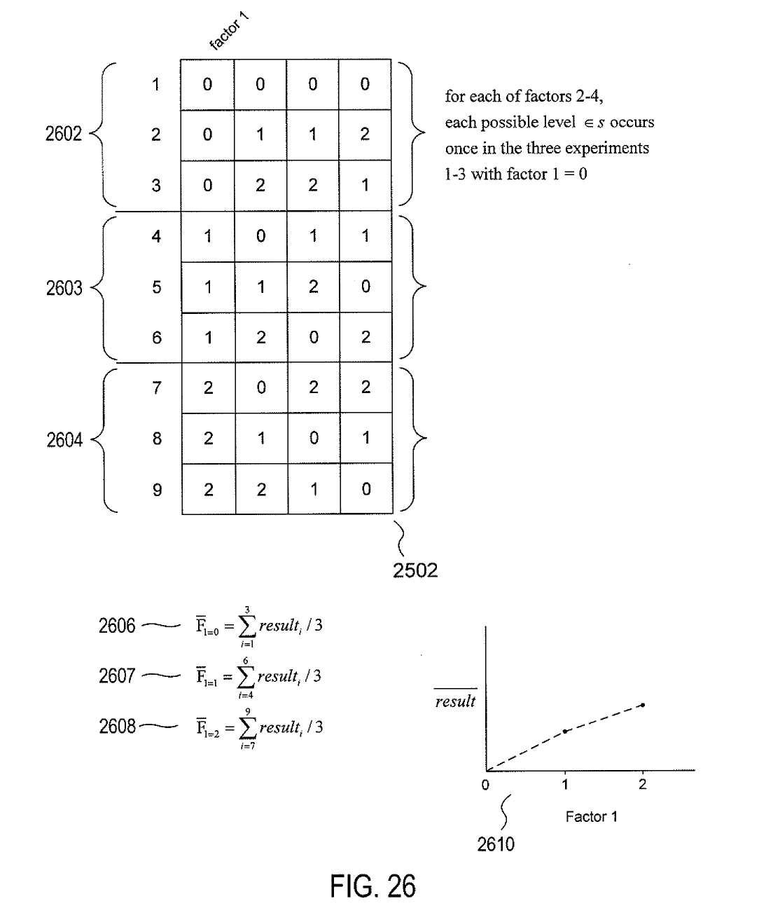

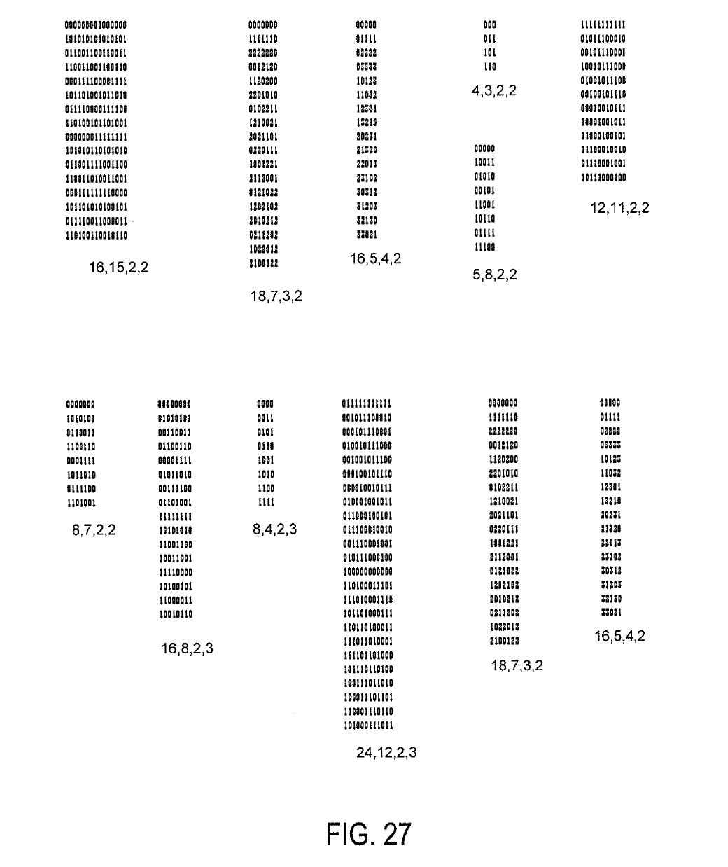

The above-described property of orthogonal arrays provides advantages in experiment design. Orthogonal arrays are balanced, in that, in the experiment design, each level occurs an equal number of times for each factor. Although an orthogonal-array-based experiment design does not provide all possible product descriptions, the product descriptions that are provided by the orthogonal array are well balanced, so that the independent effects of each factor can be readily determined. FIG. 26 illustrates analysis of experimental results produced by an orthogonal-array experiment design. FIG. 26 shows the same orthogonal array 2502 shown in FIG. 25. Consider a determination, from the product descriptions specified by the orthogonal array, of the effect of factor 1. Notice that, in the first three rows of the orthogonal array, factor 1 has level “0” 2602. In the next three rows, factor 1 has level “1” 2603. In the final three rows of the orthogonal table, factor 1 has level “2” 2604. Thus, the three-row blocks 2602-2604 represent three subsets of the orthogonal array in which the level of factor 1 is constant. Note also that, in each of these three subsets, or blocks, all possible levels of the remaining three features each occurs once. Thus, as shown in FIG. 26, an average result for the experiment when the first factor has level “0” can be computed by averaging the results obtained from the test runs in the first block 2602, as shown in expression 2606. Similarly, average results for factor 1 having level 1 and factor 1 having level 2 are obtained by averaging the results obtained from test runs in the second and third blocks, as shown in expressions 2607 and 2608, respectively. A plot of these averaged results versus the level of factor 1 2610 may reveal a trend or dependency of the results on the value, or level, of factor 1. In similar fashion, the rows of the orthogonal array can be permuted to generate similar sub-blocks for each of the other factors. Thus, the effect of each factor can be obtained by similar averaging operations. There are a large number of known orthogonal arrays. FIG. 27 illustrates a number of orthogonal arrays.

Orthogonal arrays are but one technique of many possible techniques for experiment design. DP systems may use any of these various techniques, combinations of these techniques, or variations of these techniques to design sets of product descriptions that provide a statistical meaningful computation of product-feature coefficients.

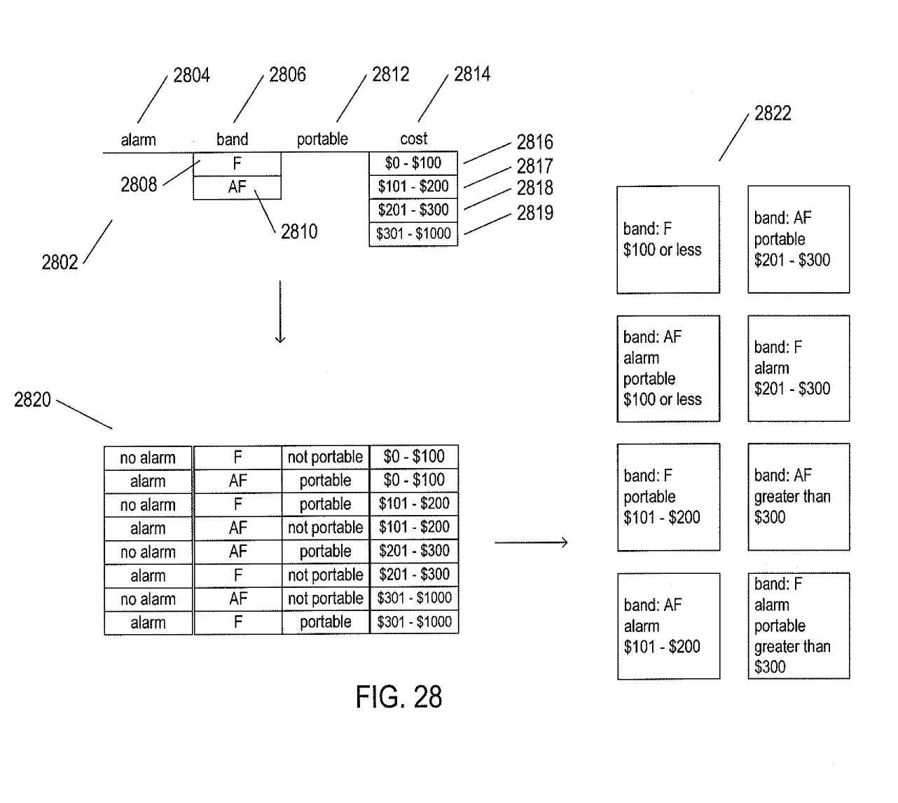

FIG. 28 illustrates an example experimental design, based on the above-described orthogonal-array technique, and generation of a set of product descriptions based on the experimental design. The initial set of conjoint features 2802 has been selected from a set of features associated with radios. The features include the presence of an alarm 2804, the frequency bands provided by the radio 2806, the values indicating FM only 2808 or both AM and FM 2810, whether or not the radio is portable 2812, and the cost of the radio 2814 associated with four different feature values or levels 2816-2819. This set of features with associated values is mapped by the DP system to an existing orthogonal array to produce the experimental design 2820. Each row in the experimental design corresponds to a different actual or hypothetical product description. Each row is thus used to generate a single product description, resulting in a set of actual and hypothetical product descriptions 2822 that can be offered to a consumer for ranking on a product-ranking page.

When a consumer successfully ranks a set of product descriptions provided to the consumer on the product-ranking page, the DP system undertakes conjoint analysis in order to determine coefficients for each of the conjoint features. 20. The product-description rankings are thus the observed experimental results. In conjoint analysis, a product ranking yᵢ for a product i is modeled as:

yᵢ=B₀+B₁+B₂x₂+B₃2x₃ . . . +e

where yᵢ is observed preference or rank,
B₀ is constant intercept,
B₁, . . . , Bₙ are coefficients,
x₁, . . . , xₙ are binary values indicating presence of feature or feature+value in product i,
e is an error term, and
n is number of independent variables.
   The terms of the example experiment illustrated in FIG. 28:

rank of product i=B₀+B₁(alarm)ᵢ+B₂(AF)ᵢ+B₃(portable)ᵢ+B₄($0-$100)ᵢ+B₅($101-$200)ᵢ+B₆($201-$300)ᵢ+eᵢ

where the coefficients include:
no alarm 0
alarm Bᵢ
F AF
not portable 0
portable B₃
$0-$100 B₄
$101-$200 B₅
$201-$300 B₆
$301-$1000 0
   The product-ranking expressions are chosen so that the set of product-ranking expressions obtained as an experimental result are linearly independent. This implies that the number of coefficients associated with a feature with n values in the product-ranking expression is n−1. In the example in FIG. 28, the feature “alarm” is either present or not present, and thus there are two features values, “no alarm” and “alarm,” associated with this feature. A single coefficient B₁ corresponding to the feature value “alarm” is used in the expression, with no coefficient used for the feature value “no alarm.” The feature value “no alarm” is therefore associated with a constant coefficient of 0, and the value determined for coefficient B₁ is relative to 0, allowing the relative importance in significance of the feature value “alarm” with respect to the feature value “no alarm” to be determined from the computed value B₁.
When a consumer has ranked all eight actual and hypothetical radio-product descriptions (2822 in FIG. 28), a set of eight rank expressions, which can be organized in tabular form, shown below, is obtained:

| y | B₁ | x₁ | B₂ | x₂ | B₃ | x₃ | B₄ | x₄ | B₅ | x₅ | B₆ | x₆ |
|---|---|---|---|---|---|---|---|---|---|---|---|---|
| 3 | B₁ | 0 | B₂ | 0 | B₃ | 0 | B₄ | 1 | B₅ | 0 | B₆ | 0 |
| 6 | B₁ | 1 | B₂ | 1 | B₃ | 1 | B₄ | 1 | B₅ | 0 | B₆ | 0 |
| 1 | B₁ | 0 | B₂ | 0 | B₃ | 1 | B₄ | 0 | B₅ | 1 | B₆ | 0 |
| 8 | B₁ | 1 | B₂ | 1 | B₃ | 0 | B₄ | 0 | B₅ | 1 | B₆ | 0 |
| 5 | B₁ | 0 | B₂ | 1 | B₃ | 1 | B₄ | 0 | B₅ | 0 | B₆ | 1 |
| 7 | B₁ | 1 | B₂ | 0 | B₃ | 0 | B₄ | 0 | B₅ | 0 | B₆ | 1 |
| 4 | B₁ | 0 | B₂ | 1 | B₃ | 0 | B₄ | 0 | B₅ | 0 | B₆ | 0 |
| 2 | B₁ | 1 | B₂ | 0 | B₃ | 1 | B₄ | 0 | B₅ | 0 | B₆ | 0 |

In conjoint analysis, the error term e is assumed to be 0 and the intercept term B₀ is ignored, since it does not affect the relative values of feature coefficients, and the table or matrix of ranking expressions can be solved for the feature coefficients by:

Y=XB

B=(X^{T}X)⁻¹X^{T}Y

When a set of product-ranking expressions is solved for the feature coefficients B, the feature coefficients can be used to rank products. In general, the higher the coefficient value, the more desired or valued the feature.

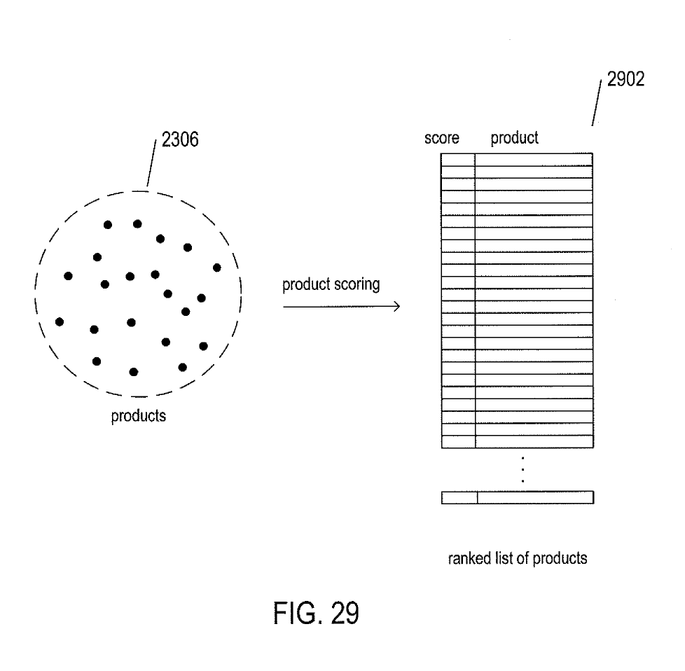

FIG. 29 shows an example DP-system computation involved in ranking available products for selection and subsequent display to a consumer on the final-results page provided to the consumer. A score is computed for each product in the filtered subset of products 2306 to produce a list of products 2902 in which each product is associated with a score. The list is then sorted by score, the highest scores corresponding to the most desirable products based on consumer information and feature coefficients determined from conjoint analysis, and the DP system then selects some number of highest-ranked products to return to the user on the results page in descending rank order.

There are many different ways to produce product scores. In one specific product-scoring method, the DP system computes an initial product score for a product as the sum of the coefficient values of all conjoint features associated with the product:

$$initial product score = {\sum }_{i = 1}^{number of coefficients} ( coefficients \text{-} present ) ( coefficient \text{-} value )$$

$$where coefficient \text{-} present = \{ \begin{matrix}1 & when present in product \\ 0 & otherwise\end{matrix} \} , and$$

$$coefficient \text{-} value = value of coefficients from least squares .$$

Next, the DP system adds the values of a number of boosts to the initial product score:

$$product score = initial product score + {\sum }_{i = 0}^{number of boosts} ( boost \text{-} present ) ( boost \text{-} value )$$

$$where boost \text{-} present = \{ \begin{matrix}1 & when predicate of boost evaluates to true \\ 0 & otherwise\end{matrix} \} , \\ and$$

$$boost \text{-} value = value associated with boost , and$$

$$boost = \{ predicate ; boost value \} .$$

The boosts provide a mechanism for supplementing coefficient values determined from conjoint analysis with additional information obtained during a consumer-interface session. Boosts can be viewed as two-part quantities, including a predicate and a boost value. When the predicate evaluates to TRUE, the boost value is added to an accumulating product score, as shown in the above expression. Any of many different boosts values may be employed. An example boost value is:

boost 1={∃ never factor j AND product is not associated with j; score ( )}.

In this boost value, if the product being scored is not associated with a never or cannot-have feature j, then the score of the product is boosted by a value returned by the function score ( ). In certain cases, the function score ( ) may receive an indication of the boost for which it is providing a score, as an argument, and return a constant value associated with the boost. In alternative scoring functions, the score returned by a boost may be computed relative to initial product score or current cumulative product score, supplied in additional arguments. Even more complex scoring functions are possible. Additional exemplary boost expressions include:

boost 1′={∀ never factors j, product is not associated with j; score ( )},

boost 2={∃ always factor k AND product is associated with k; score ( )},

boost 2′={∀ always factors k, product is associated with k; score ( )}.

Again, an almost limitless number of different types of boosts may be applied, depending on the type of product evaluated and on the particular implementation of the DP system. Further considerations that may be encapsulated in boost expressions include correspondence of features associated with the product that are highly ranked by a consumer. For example:

boost 3 {product is associated with 2 of the 4 highest ranked features; score ( )}.

In summary, the current application is directed to a class of DP systems that provide both a consumer interface that allows consumers to interact with buyers' guides and/or similar product-and-services information-provision services and a client interface that allows clients to obtain market research and analyses based on a large number of various types of information collected by the DP system during consumer interactions with the buyers' guides and/or similar product-and-services information-provision services, as well as additional stored information. The DP systems in this class of DP systems are truly dual-purpose, in that they provide valuable product information to consumers as well as valuable marking-research information and analyses to business and commercial clients. The consumers interacting with buyers' guides represent a group of consumers that are actually sufficiently interested in the products described in buyers' guides to expend the effort to complete a consumer-interface session, and are thus highly desirable candidates for supplying meaningful market-research information to clients. Furthermore, the copious amount of data collected during consumer-interface sessions provides valuable feedback information and interaction information that can be used to qualify and validate data provided clients and analyzed on behalf of clients and to constantly improve the consumer interface. Significantly, consumers, during interaction with buyers' guides, provide data with respect to actual and hypothetical products of real interest to the consumers, since the actual and hypothetical products ranked by the consumers are based on feature selections and prioritizations made by the consumers. Thus, DP systems provide to clients high quality market-research information and analyses at the cost of providing valuable product information through buyers' guides to consumers.

Although the present invention has been described in terms of particular embodiments, it is not intended that the invention be limited to these embodiments. Modifications within the spirit of the invention will be apparent to those skilled in the art. For example, many different DP system implementations can be obtained by varying any of many different design and implementation parameters, including choice of number and types of hardware components, operating systems, modular organization control routines, data structures, control structures, programming languages, and many other such design and implementation parameters. The protocols incorporated in consumer-interface sessions can be varied, and the computational techniques employed to generate conjoint-feature coefficients and product scores may vary as well. The types of information provided to consumers during consumer-interface sessions may also vary. Any of a large number of different types of market-research information and analyses can be provided based on the large amount and variety of data harvested by the DP system during consumer-interface sessions. The analyses include gap analyses, product-line-up analyses, sensitivity analyses and compiled statistics, as discussed above, that may include a large variety of different additional types of analyses.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A dual-purpose, automated system comprising:
one or more computer systems that each includes
at least one processor,
at least one electronic memory,
at least one communications port, and
at least one mass-storage device; and
computer instructions, stored in at least one of the at least one electronic memory of the one or more computer systems, that when executed by at least one of the at least one processor of the one or more computer systems, control operation of
a consumer interface through which the dual-purpose, automated system transmits data about one or more of products and services and through which the dual-purpose, automated system receives product-feature selections, product rankings, and consumer-interface-interaction data for storage in at least one mass-storage device, and
a client interface through which the dual-purpose, automated system transmits result data generated by processing the product-feature selections, product rankings, and consumer-interface-interaction data stored in the at least one mass-storage device.

2. The dual-purpose, automated system of claim 1 wherein the consumer interface comprises one or more electronic buyers' guides.

3. The dual-purpose, automated system of claim 2 wherein the electronic buyers' guide provides information about one or more of products and services by:
receiving a request for information about a particular type of product or service;
transmitting a request for consumer information and receiving the consumer information;
transmitting a request for product-feature selections and receiving the product-feature selections;
transmitting a request for product rankings and receiving the product rankings; and
transmitting an ordered list of product information about particular products, the particular products and list orderings determined from data extracted from the received consumer information, the received product-feature selections, and the received product rankings.

4. The dual-purpose, automated system of claim 3 wherein the dual-purpose, automated system partitions the received product-feature selections into conjoint features and filter features.

5. The dual-purpose, automated system of claim 3 wherein the dual-purpose, automated system employs filter features extracted from the received product-feature selections to select a subset of available products described by product information stored within the dual-purpose, automated system and the dual-purpose, automated system constructs an experiment design using conjoint features extracted from the received product-feature selections.

6. The dual-purpose, automated system of claim 3 wherein the dual-purpose, automated system generates and stores a set of product descriptions based on one or more of:
selected features;
derived features; and
feature values.

7. The dual-purpose, automated system of claim 3 wherein the dual-purpose, automated system generates a set of coefficients by analyzing the received product rankings, each coefficient in the set of coefficients corresponding to on one or more of:
a feature;
a derived feature; and
a feature value.

8. The dual-purpose, automated system of claim 3 wherein the dual-purpose, automated system generates a score for each product in a set of available products by:
computing an initial score as a sum of terms, each term corresponding to a coefficient generated by analyzing the received product rankings; and
adding to the initial score values of one or more boost terms based on data extracted from the received consumer information, received product-feature selections, and received product rankings.

9. The dual-purpose, automated system of claim 3 wherein, after transmitting the ordered list of product information about particular products, the dual-purpose, automated system receives and stores one or more requests for additional product information.

10. The dual-purpose, automated system of claim 3 wherein, after transmitting the ordered list of product information about particular products, the dual-purpose, automated system receives and stores one or more feedback data related to the ordered list of product information.

11. The dual-purpose, automated system of claim 3 wherein, in addition to receiving consumer information, product-feature selections, and product rankings, the dual-purpose, automated system receives and stores data related to interaction of a consumer with the consumer interface, including one or more of:
the time and date of a consumer request or selection;
the spatial distribution of selections with respect to a displayed web page;
the time between pairs of consumer requests and selections; and
the number and identities of consumer interactions with consumer-interface web pages.

12. The dual-purpose, automated system of claim 1 wherein the result data generated by processing the product-feature selections, product rankings, and consumer-interface-interaction data stored in the at least one mass-storage device includes one or more of:
product-feature-selection information and statistics;
a gap analysis;
a what-if analysis;
a sensitivity analysis; and
a product-lineup analysis.

13. A method that produces, electronically stores, and transmits market research and market analyses, the method comprising:
providing an electronic information service through a consumer interface and a market-research-and-market-analysis service through a client interface, the consumer interface and client interface implemented by one or more computer systems that each includes at least one processor, at least one electronic memory, at least one communications port, at least one mass-storage device, and computer instructions stored in the at least one electronic memory;
receiving and storing, in the at least one mass-storage device, product-feature selections, product rankings, consumer information, and consumer-interaction information through the consumer interface;
generating and storing market-research results and market-research analyses from the stored product-feature selections, product rankings, consumer information, and consumer-interaction information; and
transmitting one or more of the generated market-research results and market-research analyses through the client interface.

14. The method of claim 13 wherein the information provided through consumer interface includes one or more of:
product information; and
services information.

15. The method of claim 13 wherein the information provided through consumer interface comprises an ordered list of information about products, the list ordered by scores generated for each of a set of available products.

16. The method of claim 15 wherein each score is generated as a sum of product-feature coefficients and boost terms.

17. The method of claim 1 wherein the generated and stored market-research results and market-research analyses include:
product-feature-selection information and statistics;
a gap analysis;
a what-if analysis;
a sensitivity analysis; and
a product-lineup analysis.

18. Computer instructions stored in a computer-readable medium that implement a method that produces, electronically stores, and transmits market research and market analyses, the method comprising:
providing an electronic information service through a consumer interface and a market-research-and-market-analysis service through a client interface, the consumer interface and client interface implemented by one or more computer systems that each includes at least one processor, at least one electronic memory, at least one communications port, at least one mass-storage device, and computer instructions stored in the at least one electronic memory;
receiving and storing, in the at least one mass-storage device, product-feature selections, product rankings, consumer information, and consumer-interaction information through the consumer interface;
generating and storing market-research results and market-research analyses from the stored product-feature selections, product rankings, consumer information, and consumer-interaction information; and
transmitting one or more of the generated market-research results and market-research analyses through the client interface.
